(19) United States
(12) Patent Application Publication
(10) Pub. No.: US 2010/0085916 A1
(43) Pub. Date: Apr. 8, 2010

(54) Systems and Methods for Hybrid Wired and Wireless Universal Access Networks

(75) Inventors: John Z. Yu, Palo Alto, CA (US); David H. Hsu, Great Neck, NY (US); Henry Z. Zhang, Cupertino, CA (US)

Correspondence Address: Venture Pacific Law, PC, 5201 Great America Parkway, Suite 270, Santa Clara, CA, 95054, US

(73) Assignee: NOOSPHERE COMMUNICATIONS, INC., Sunnyvale, CA (US)

(21) Appl. No.: 12/534,065

(22) Filed: Jul. 31, 2009

Related U.S. Application Data
(63) Continuation-in-part of application No. PCT/US2008/052701, filed on Jan. 31, 2008.
Application No. PCT/US2008/052701 is a continuation-in-part of application No. PCT/US2008/052695, filed on Jan. 31, 2008.
(60) Provisional application No. 60/898,874, filed on Jan. 31, 2007.
(60) Provisional application No. 60/898,959, filed on Jan. 31, 2007.

(51) Int. Cl. H04W 40/00; H04L 12/56

(52) U.S. Cl. 370/328; 370/401

(57) ABSTRACT

A method for operating a network having one or more nodes wherein each of the nodes having one or more resources, comprising the steps of: forming the network using one or more nodes, wherein certain one or more of the nodes is a gateway connecting to two or more different network connection types; and managing the one or more nodes of the network; wherein the nodes are segregated into one or more cells each having one or more of the nodes and one or more supernodes; wherein the nodes within the same cell are interconnected; and wherein the supernodes are interconnected.

### CROSS REFERENCE

This application claims priority to and is a continuation in part from a Patent Cooperation Treaty (“PCT”) application entitled “A Hybrid Wired and Wireless Universal Access Network” filed on Jan. 31, 2008 and having an Application No. PCT/US2008/052701 and a PCT application entitled “A Gateway Switch for Hybrid Wired and Wireless Communications” filed on Jan. 31, 2008 and having an Application No. PCT/US2008/052695. Additionally, this application claims priority from a United States provisional application entitled “A Hybrid Wired and Wireless Universal Access Network” filed on Jan. 31, 2007 and having an Application No. 60/898,959 and a United States provisional application entitled “A Gateway Switch for Hybrid Wired and Wireless Communications” filed on Jan. 31, 2007 and having an Application No. 60/898,874. Said applications are incorporated herein by reference.

### FIELD OF INVENTION

This invention relates to systems, methods, and apparatuses for a hybrid wired and wireless network. In particular, this invention relates to a hybrid wired and wireless communication network and a gateway switch for supporting such hybrid wired and wireless communication.

### BACKGROUND

As the Internet increasingly becomes mature and ubiquitous, traditional business and services, including communications and commerce, have been migrating over to the Internet. A long-standing challenge however remains of the Internet access problem, specifically the “last mile” problem. As Internet access via fixed-lines (e.g., ADSL, cable, and dedicated lines) has been widely deployed, the development for Internet access via wireless devices (e.g., mobile handsets or PCs) has now moved to the center stage of the evolution of the communications industry.

In recent years, wireless local area networks (“WLAN”) based on standard WiFi/WiMax technologies have been extensively developed for mobile and wireless users to access a wired backbone network such as the Internet. WLAN operates in an ad-hoc manner typically with single-hop connections. The construction of WLAN consists of access points, referred to as “hot spots”, connected to a backbone network with wired connections (known as “backhauling”), and to WLAN cards in user wireless devices (e.g., mobile handsets or laptop computers). WLAN is widely deployed in the SOHO (single office/home office) environment and concentrated commercial areas (e.g., hotels, restaurants, shopping malls, etc.) for Internet access for wireless devices. WLAN also supports other Internet applications such as peer-to-peer communication mainly for VOIP (Voice Over Internet Protocol) and file transfer directly between end users.

A key challenge of WLAN is the wireless coverage capability as each access point can only cover a limited area, typically a few hundred feet in distance due to fundamental radio transmission limits. To provide ubiquitous wireless Internet access, the access points must be deployed in high density. Additionally, it is a significant technological and financial challenge to backhaul each access point with wired connections to the Internet. Even more recently, substantial efforts have been made to build a special type of WLAN, wireless mesh networks, which are based on the advance of WLAN technologies to reduce the backhauling requirement.

The wireless mesh network is a strong candidate for a universal wireless access network which allows a user to access the network from anywhere at anytime. There are, however, some key challenges to building such a network in terms of network performance, financial requirement, and operations complexity.

First, when connecting a user to the backbone network via multiple hop wireless links, the connection performance (e.g., bandwidth, throughput, and/or delay) is severely degraded as the number of hops increases, which is especially the case when considering wireless link quality that is time-varying and unstable (e.g., prone to interference from the surrounding environment). Highly intelligent, real-time dependent network signaling and routing/re-routing protocols need to be designed for improving quality-of-service. As a result, the number of wireless hops must be upper-bounded, hence the scale of a wireless mesh network is limited, and the sophisticated networking technologies must be implemented and maintained.

Second, as the number of hops for a connection is limited to improve the scalability of a wireless mesh network, a substantial portion of access points needs to be wired to the backbone network. Immense financial investment is thus required to deploy a sufficient number of access points with a sufficient number of backhauling wired connections for building and operating a sophisticated large-scale wireless mesh network.

Third, from the network deployment operations perspective, to deploy a large number of access points in a commercial or “open space” area, not only does the deployed access points need to be maintained and managed, thus incurring substantial cost, but municipal governmental approvals may be needed to be sought and granted to make such a network deployment feasible.

Lastly, from a node's perspective in a mesh network, it is difficult to build a universal gateway switch that can access different types of services over different networks such as mobile cellular networks, public switched telephone networks (“PSTN”), cable networks, WiFi/WiMax wireless networks, and the Internet. It is also difficult to enable the service access and service interworking among the above-mentioned networks, and to facilitate the convergence of different services over different networks toward the Internet.

Therefore, the operations complexity and associated cost to build a high-performance conventional wireless mesh network can be horrendous. A solution of how to make the evolving scalable and high-performance wireless mesh networking technologies integrated with and leveraged over the current and possible future network infrastructure for ubiquitous wired and wireless access is needed. An ideal solution would enable a seamless deployment of a universal access network connected possibly by a mixture of wired and wireless links or by a hybrid wired and wireless universal access network, where the universal access network is a “hybrid” mesh network that can have scalable, high-performance, and minimal operations complexity for deployment and maintenance.

Furthermore, it would be desirable to provide systems, methods, and apparatuses for a universal gateway switch, which can access different types of services over different existing networks, such as mobile cellular networks, PSTN, cable networks, WiFi/WiMax wireless networks, satellites, and the Internet, to enable service access and service interworking among the above-mentioned networks, and to facilitate the convergence of different services over different networks toward the Internet.

### SUMMARY OF INVENTION

The various embodiments described below address the above-described problems with respect to building a hybrid wired and wireless universal access network. The objective of such a network would serve as an enabling network, superimposed over various existing networks for network access and network and service interworking, while the network is self-contained to form a network by its own, and to also serve as a multi-purpose platform network over which many existing and future innovative applications and business models can be enabled for communications, computing, and control for a wide range of applications.

A method for operating a network having one or more nodes is disclosed, wherein each of the nodes having one or more resources, comprising the steps of: forming the network using one or more nodes, wherein certain one or more of the nodes is a gateway connecting to two or more different network connection types; and managing the one or more nodes of the network; wherein the nodes are segregated into one or more cells each having one or more of the nodes and one or more supernodes; wherein the nodes within the same cell are interconnected; and wherein the supernodes are interconnected.

A network comprises: one or more nodes, wherein certain one or more of the nodes is a gateway connecting two or more network connection types, and wherein each of the nodes having one or more resources; and one or more supernodes; wherein the nodes are segregated into one or more cells each having one or more of the nodes and one or more of the supernodes; and wherein the nodes and the supernodes of the same cell are interconnected and the supernodes of the cells are interconnected.

### DESCRIPTION OF THE DRAWINGS

The foregoing and other objects, aspects, and advantages of the invention will be better understood from the following detailed description of the preferred embodiment of the invention when taken in conjunction with the accompanying drawings in which:

FIG. 1 illustrates a general network architecture of a hybrid wired and wireless universal access network, RizoNet, of the present invention.

FIG. 2 illustrates a general network view of a gateway switch, RizoNode, of the present invention connected to various networks.

FIG. 3 illustrates a block diagram for an embodiment of this invention for a gateway switch, RizoNode.

FIG. 4 illustrates another network view of a RizoNet, where the RizoNet has two RizoCell subnets.

FIG. 5 illustrates a flow chart for generating a RizoNet of the present invention, where the RizoNet can be partitioned into RizoCells.

FIG. 6 illustrates a flow chart for a node joining the RizoNet.

FIG. 7 illustrates a flow chart for determining whether to partition a network into multiple cells.

FIG. 8 illustrates various methods for connecting the SNs of the cells/subnets.

FIG. 9 illustrates a network view of the cells connected with each other in a mesh-like topology.

FIG. 10 illustrates a network view of the cells connected with each other using a second degree regular graph topology.

FIG. 11 illustrates a network view of the cells connected with each other taking into account network characteristics.

FIG. 12 illustrates a network view of a node joining a RizoNet of the present invention.

FIG. 13 illustrates a network view of a second node and a third node joining a RizoNet of the present invention.

FIG. 14 illustrates a network view of a RizoNet with 12 nodes.

FIG. 15 illustrates a network view of a result of partitioning a RizoNet into two cells.

FIG. 16 illustrates a network view of SNs and network tunnels between the cells of the RizoNet.

FIG. 17 illustrates a flow chart for a routing algorithm for use in a RizoNet of the present invention.

FIGS. 18a and 18b illustrate a routing map of a result for routing a packet from a starting node, node 21, to a destination node, node n, using a routing protocol.

FIG. 19 illustrates an embodiment of the network management system (“NMS”), R-manager, of a RizoNet of the present invention.

FIG. 20 illustrates an R-manager running on a management server, a RizoNode, and a configuration terminal for the RizoNode.

FIG. 21 illustrates an R-manager running on a configuration terminal that is locally connected to a RizoNode.

FIG. 22 illustrates an R-manager running on a management server that is remotely connected to a RizoNode.

FIG. 23 illustrates a block diagram of an embodiment of the present invention for a RizoNode.

FIG. 24 illustrates a block diagram of a hardware schematic for an embodiment of the present invention for a RizoNode that supports voice applications.

FIG. 25 illustrates a block diagram of a mobile handset that can perform voice and data communications connecting to a gateway communications switch, RizoNode.

FIG. 26 illustrates a network architecture for performing voice and data communications via a gateway communications switch, RizoNode.

FIG. 27 illustrates various adapters that are connected to a computer and that run a program, referred to as Vortex, to perform gateway communications switch, RizoNode, functions.

FIG. 28 illustrates an architectural diagram of an embodiment of the present invention referred to as a BlueLite (“BL”) adapter.

FIG. 29 illustrates a flow chart for setting up a connection between a cellular phone with BlueTooth (“BT”) capability, a headset with BT capability, and a BL adapter.

FIGS. 30a and 30b illustrate a process flow for a cellular phone connected to a network via a BL adapter for accessing data and voice communications.

FIG. 31 illustrate a network view of an embodiment of the present invention for a virtual aggregate link.

FIG. 32 illustrates an embodiment of a content distribution network (“CDN”) of a RizoNet of the present invention.

FIG. 33 illustrates an embodiment of a grid computing network (herein may referred to as a “GCN”) of the RizoNet of the present invention.

FIG. 34 illustrates an embodiment of a home-networking network (“HNN”) of the RizoNet of the present invention.

### DETAILED DESCRIPTION OF THE PREFERRED EMBODIMENTS

### Overview of a RizoNet Architecture

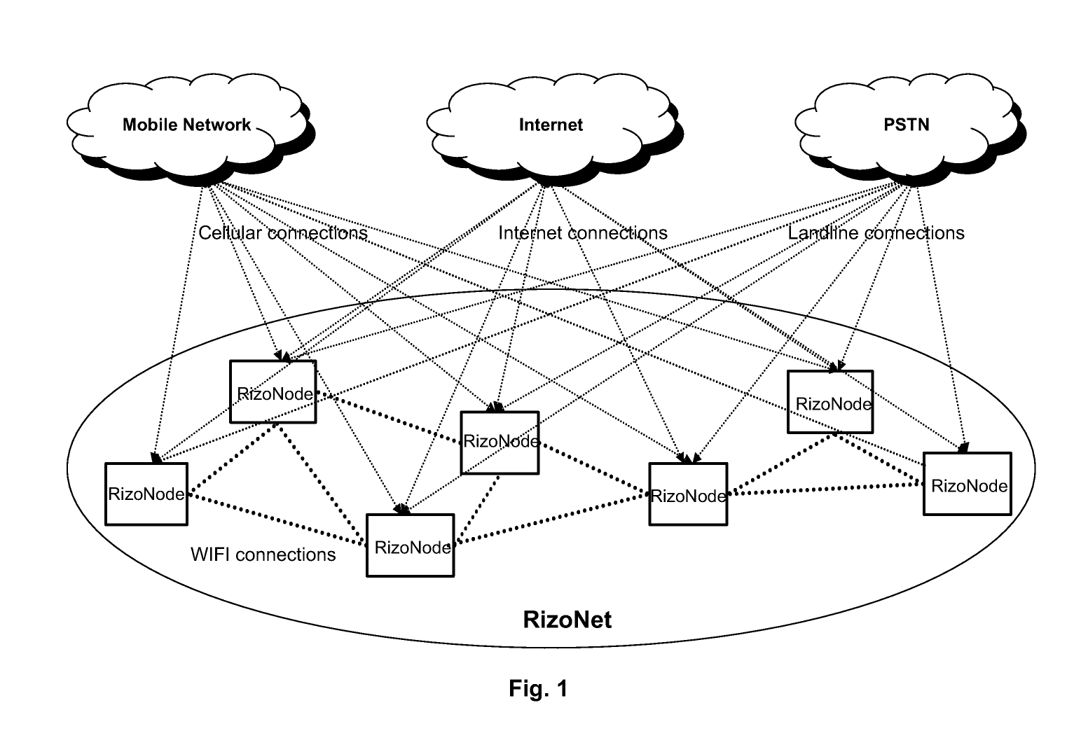

FIG. 1 illustrates a general network architecture of a hybrid wired and wireless universal access network of the present invention. A hybrid wired and wireless universal access network can be herein referred to as a RizoNet. A RizoNet comprises of dynamically deployed universal gateway switches as the network nodes, which can be referred to as RizoNodes.

The RizoNet connects to one or multiple backbone networks, which can be the Internet, a mobile cellular network, a cable network, a landline PSTN, a public wireless network, satellites, or other networks. The RizoNodes are interconnected with each other via single-hop and/or multiple-hop wired/wireless links and/or connections over the multiple existing networks in the RizoNet.

The nodes in the RizoNet can be gateway switches (e.g., RizoNodes or other network nodes), which are communication devices and can be connected in two ways: (1) by vertical connections, meaning a RizoNode can be a gateway connecting to the Internet, a mobile network, a cable network, a PSTN, and other backbone networks, and switching traffic between these networks; and (2) by horizontal connections, meaning RizoNodes can connect with each other through wired and wireless links to form a network, e.g., a WiFi/WiMax network to form a wireless mesh network. A horizontal connection is not limited to WiFi/WiMax connections, but can be any type of connection such as a LAN connection, wired connection, wireless connection, or other types of connections and combinations of connections.

As a result, the RizoNet can provide access and interworking over the RizoNet and the multiple existing networks. A path connecting two RizoNodes in the RizoNet may comprise a sequence of network nodes interconnected by a mixture of either wired or wireless links (e.g., horizontal connections and vertical connections) as performance allows for end-to-end quality of service. The scalability of the RizoNet is not constrained since the number of hops for a path between two RizoNodes can always be limited by using “short-cut” vertical connections.

In a sense, the RizoNet is a 3-dimensional hybrid access network in which two RizoNodes can be connected by single-hop or multi-hop WiFi/WiMax connections, or the Internet/mobile/cable/landline connections, or a path mixed with the various types of connections. Furthermore, RizoNet can integrate and interoperate over multiple networks, such as the Internet, mobile networks, cable networks, PSTN, WiFi/WiMax networks, satellite networks, and other networks. From a network topology perspective, the RizoNet can be a network based on a “hyper-graph”, i.e., multiple heterogeneous direct links between a pair of nodes in the network topology graph.

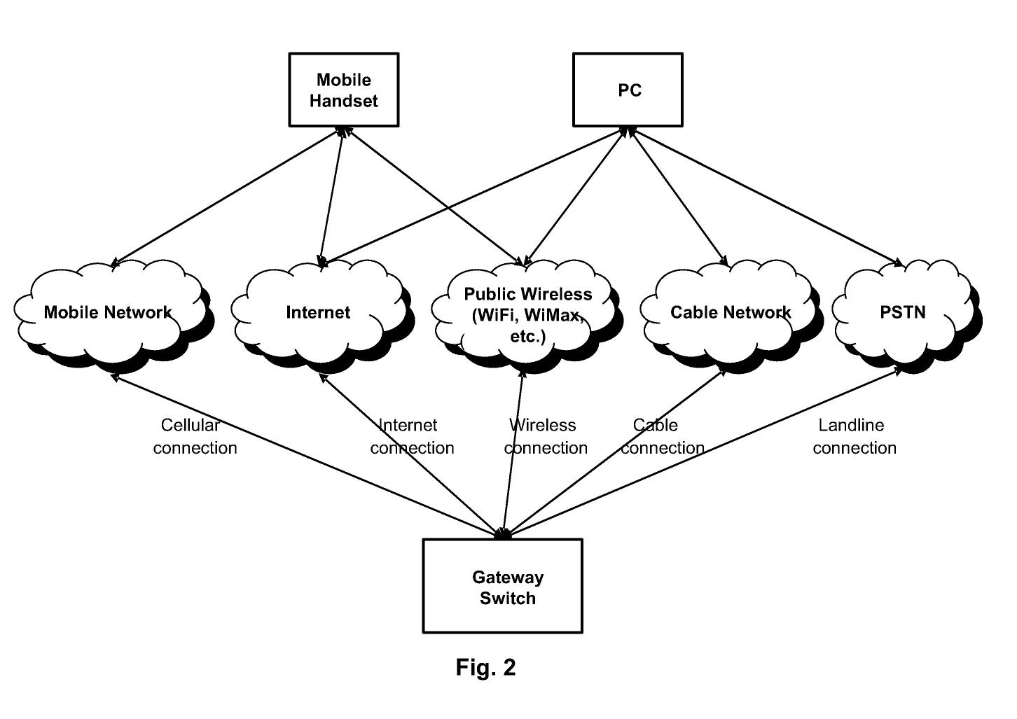

FIG. 2 illustrates a general network view of a gateway switch of the present invention connected to various networks. Each gateway switch may connect to multiple networks, such as mobile cellular networks (such as GSM, CDMA, CDMA2000, WCDMA, TD-SCDMA, 4G-mobile, etc.), the Internet, PSTN, a fixed wireless backhauling network, a cable network, a wired local area network, a wireless network (such as WiFi, WiMax, etc.), other networks, and combinations thereof. The gateway switch can receive data from the multiple networks and from multiple devices connected to the gateway switch, process that data for a selected network connection type (e.g., cellular connection, Internet connection, wireless connection, cable connection, PSTN connection, other network connections, or simultaneously over various network connection types), and then transmit the processed data via the selected network connection type to any destination device (e.g., a mobile handset, personal computer, other device, or other destination).

A RizoNode can be viewed as a network demarcating and service enabling platform for service access and network and service interworking. The RizoNode can connect to multiple existing networks, such as mobile cellular networks, the Internet, PSTN, WiFi/WiMax networks, satellite networks, and other networks. In a distributed fashion, the RizoNode sits between the above-mentioned multiple existing networks to convert and transfer traffic from one format to another format, and from one network to another network.

A RizoNode gateway switch comprises a processor engine, an operating system and protocol stacks, a memory storage, and a wide range of access and network interface modules. The access and network interface modules can be also referred to as transceiving modules. Transceiving modules may include one or more of a transmitting device for transmitting data and a receiving device for receiving data. In some embodiments, a RizoNode comprises (a) a set of transmitting devices, (b) a switching and control device, and (c) a set of receiving devices. The set of transmitting devices is capable of transmitting voice and/or data signals over a wired or wireless network. It is important to note that voice signals and data signals are not mutually exclusive, and that data signals can include voice signals. The set of receiving devices is capable of receiving voice and/or data signals from a wired or wireless network. The switching and control device is capable of receiving the incoming voice and/or data signals from the set of receiving devices, and then process and convert the signals to appropriate formats with certain designated identifiers. The process and converted signals can then be sent to one or more specific transmitting devices according to service-specific rules for forwarding the signals via a specific wired or wireless network connected to the RizoNode.

A key function of a RizoNode is symmetric switching, where symmetric switching can mean the ability to switch from a receiving device to any transmitting device. Specifically, the RizoNode can receive incoming voice and data signals from the set of receiving devices, and then process and convert the signals to appropriate formats with certain designated identifiers. The process and converted signals can then be sent to a specific transmitting device. It is important to note that the RizoNode is not limited to sending voice and data signals through one network and through one specific transmitting device. The RizoNode can concurrently send voice and data signals using multiple networks and transmitting devices.

Symmetric switching selects one or more specific transceiving modules based on one or more of the following: the application used to receive or transmit data, the respective application protocol of the application, service-specific rules, user-specific rules, availability and status of the networks that are available to the RizoNode, the format of the received data, the data type of the received data, an identifier of the received data, the format of the transmitted data, on the transceiving module that received the data, and other factors.

For instance, if a user requests to place a phone call to a destination number using a RizoNode, the RizoNode can check the status of the backbone network connections before selecting a transmitting device to place the call. If multiple backbone network connections are available such as the Internet, a PSTN, and a cellular network, the RizoNode can use preconfigured settings for a phone application to select a network for setting up the call.

Based on these preconfigured settings, the RizoNode can first attempt to place the call via the PSTN. If the call is unsuccessful, the RizoNode can make a second attempt by placing the call via VOIP over the Internet, and so on and so forth as prescribed by the preconfigured settings. The order of networks and the types of networks used are merely an example of the many different preconfigured settings for selecting various networks to setup voice and data communications.

The settings can also be overridden by user specified selections, such that a user can select which network to first use to place the call. Additionally, the RizoNode may select an available network to place the call by cycling through the available networks in a round-robin fashion, or in a random fashion.

As stated above, symmetric switching can be based on the application used. For instance, if a user requests to send an instant message via the RizoNode, the RizoNode may have different preconfigured settings for an instant message application than a phone application, such that in the first attempt, the RizoNode will send the instant message via the Internet. If unsuccessful, then the RizoNode will use the second choice, and so on and so forth.

In some embodiments, service-specific rules can comprise one or more of the following: forwarding rules based on a wireless voice service plan of a user; forwarding rules based on a mobile voice or data service plan of a user; forwarding rules based on a landline telephone voice or data service plan of a user; forwarding rules based on a voice or data service plan to establish the connection (through traditional connections or VOIP) over a PSTN network, a cable network, the Internet, a cellular network, a WiFi/WiMax mesh wireless network, a satellite network, or other networks.

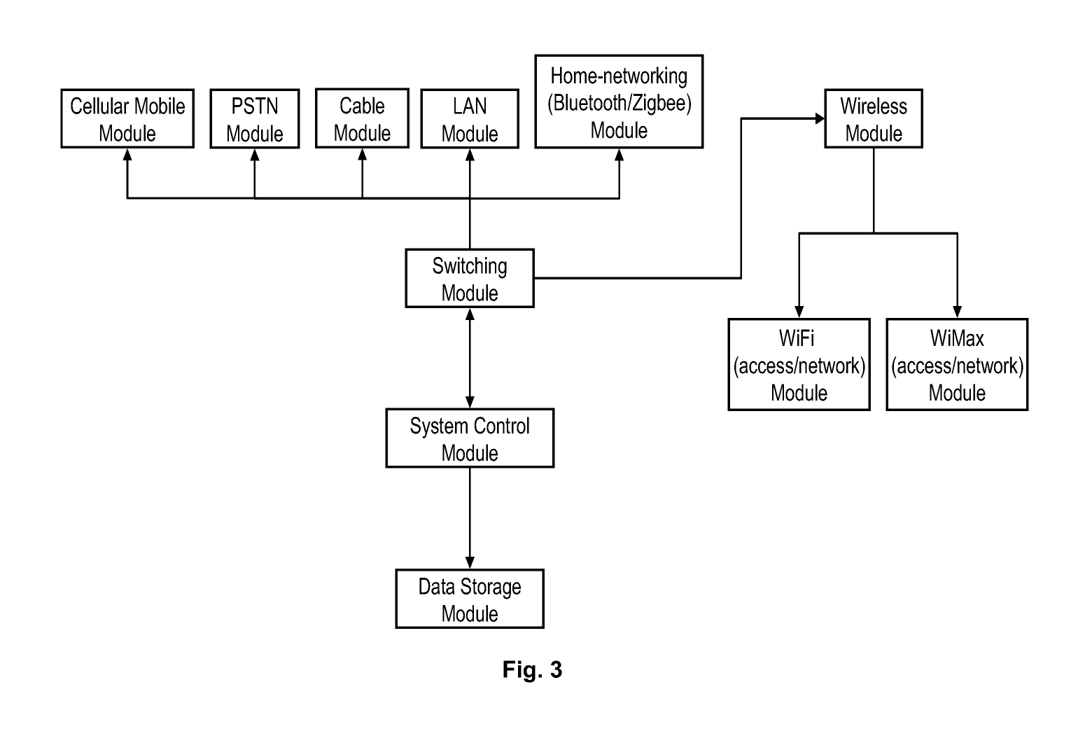

FIG. 3 illustrates a block diagram for an embodiment of this invention for a gateway switch. The transmitting and the receiving devices comprise a cellular network (e.g., GSM, CDMA, CDMA2000, WCDMA, TD-SCDMA) module, a landline PSTN module, a cable module, a LAN (e.g., Ethernet) module, a home-networking (e.g., Bluetooth, Zigbee, or other protocol standard) module, and a wireless local area networks (e.g., WLAN, WiFi, or WiMax) module. A RizoNode can also comprise the following: a system control module (also can be referred to as a system module) for system control and management; a switching module for converting and transferring traffic from one format to another format and from one network to another network; and a data storage module.

The gateway switches, or RizoNodes, form the nodes for a hybrid wired and wireless universal access network, the RizoNet. The backbone network behind the RizoNet can be the Internet, a fixed wireless backhauling network, a cable network, a landline PSTN network, a wired local area network (LAN), a satellite network, other networks, and combinations thereof.

### RizoNet

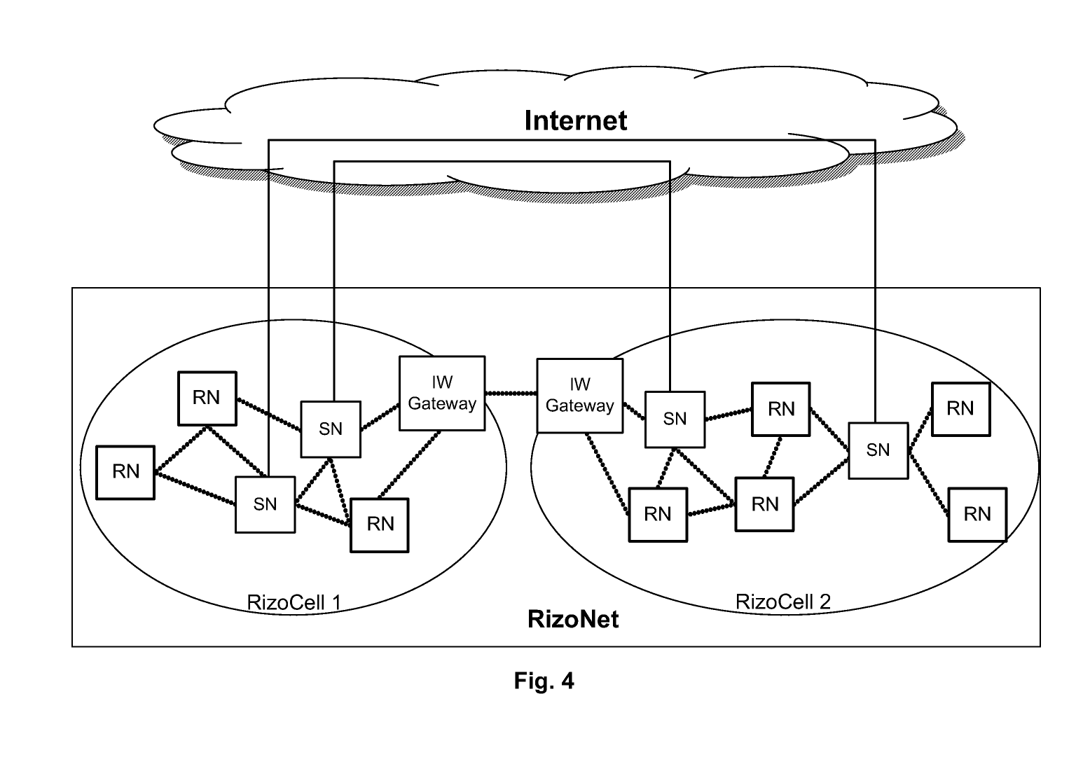

FIG. 4 illustrates another network view of a RizoNet, where the RizoNet comprises two subnetworks. In some embodiments, the RizoNet can further comprise one or more subnetworks. The subnetworks can be referred to as RizoCells, cells, clusters, network clusters, or simply networks. A RizoCell may include at least one regular RizoNode (“RN”) and at least one super RizoNode (“SN”). Additionally, each RizoCell can also have sub-cells. The SN is the leader in the subnetwork for coordination and management.

A RizoCell can be a network cluster in which one or more SNs and a set of RNs form an integral subnetwork domain. In some embodiments, the RizoNet can include two or more RizoCells, in which the two or more RizoCells can be connected via network tunnels (e.g., IP tunnels) by and between the SNs of each respective RizoCell. In some embodiments, each RizoCell can include one or more RizoNodes that service as dedicated gateways for interconnecting RizoCells, which can also be referred to as interworking (“IW”) gateways. Two or more RizoCells can be connected by a dedicated trunk (e.g. private line or microwave link) between the one or more IW gateways of the respective RizoCells.

A SN in a RizoCell can be selected from the RNs in the RizoCell according to one or more criteria. Some examples of such criteria can be location coordinates of the nodes, network topology, processing capacity of the node, handover capability, service profile, service availability, performance level, routing metrics, accounting and billing policy, other administrative policy, and other criteria. The SNs in a RizoCell can be fully connected via network tunnels. A special protocol can be designed to maintain the connectivity among the SNs in a RizoCell. Each SN in a RizoCell maintains the network topology for the RizoCell, and serves as the default gateway router for routing traffic for other RNs in the RizoCell.

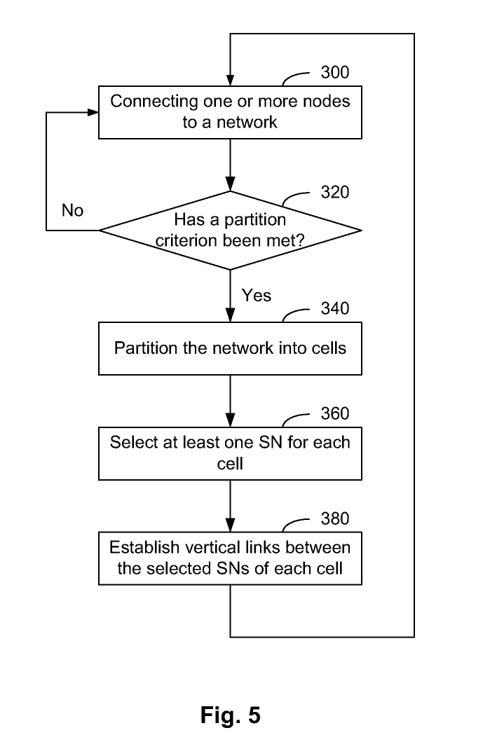

FIG. 5 illustrates a flow chart for generating a RizoNet of the present invention, wherein the RizoNet can be partitioned into RizoCells. Network formation is performed by connecting one or more nodes to a network, wherein the network can mean the RizoNet or a cell within the RizoNet 300. Next, it is determined whether the network has met a partition criterion 320 (e.g., if a maximum number of nodes has been reached for the network or a cell in the network, or based on other criteria). If a partition criterion has not been met, nodes can continue to join the network.

If a partition criterion has been met, the network is partitioned into new cells 340. At least one SN is selected for each new cell 360. In order to increase throughput and improve overall efficiency of the network, the connections between the nodes in the different cells are severed, and new connections between the nodes within a new cell are established. In addition, new connections between SNs of the new cells are established. In the preferred embodiments, two SN are selected for each new cell, where a first SN can be referred to as the “primary SN” and a second SN can be referred to as the “secondary SN”. The purpose of having two SNs is to improve network efficiency and robustness. After the SNs are selected, vertical links (e.g., network tunnels) can be established to connect SNs of one cell to SNs of other cells 380.

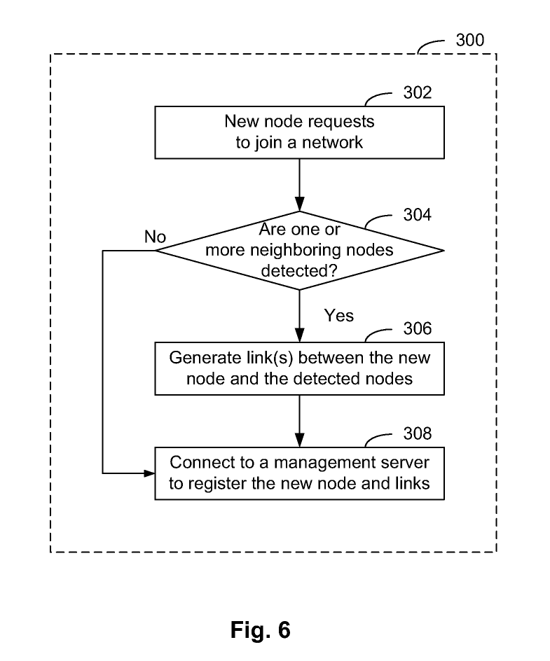

With respect to new nodes joining the network 300, FIG. 6 illustrates a flow chart for a new node joining the RizoNet. A new node can also be referred to as a requesting node. When a new node joins the network 302, the new node searches for neighboring nodes in its vicinity 304, where the vicinity can be based upon a geographical area, a service area, the range of the node's capability to sense other nodes, or other criteria. For instance, in a WiFi mesh network, a new node can search for other neighboring nodes within the range of its WiFi radio. The new node can identify neighboring nodes using a naming system with respect to the network to detect whether the sensed nodes are part of the network.

If the new node detects one or more neighboring nodes, then the new node, in working with a management server, can be directed to connect with one or more neighboring nodes, forming a link between the new node and the selected neighboring nodes 306. Information regarding the new node and the generated new links (if any) can be maintained by the management server for registration and tracking of the network topology 308. A management server can be a server running a management software, e.g., a R-manager, and physically reside in a management center, e.g., a Z-center.

If the new node does not detect any neighboring nodes, then the new node can register itself with the management server 308. The management server can then provide a list of nodes (if any) to the new node that the new node can attempt to connect with to join the RizoNet (or a RizoCell of the RizoNet).

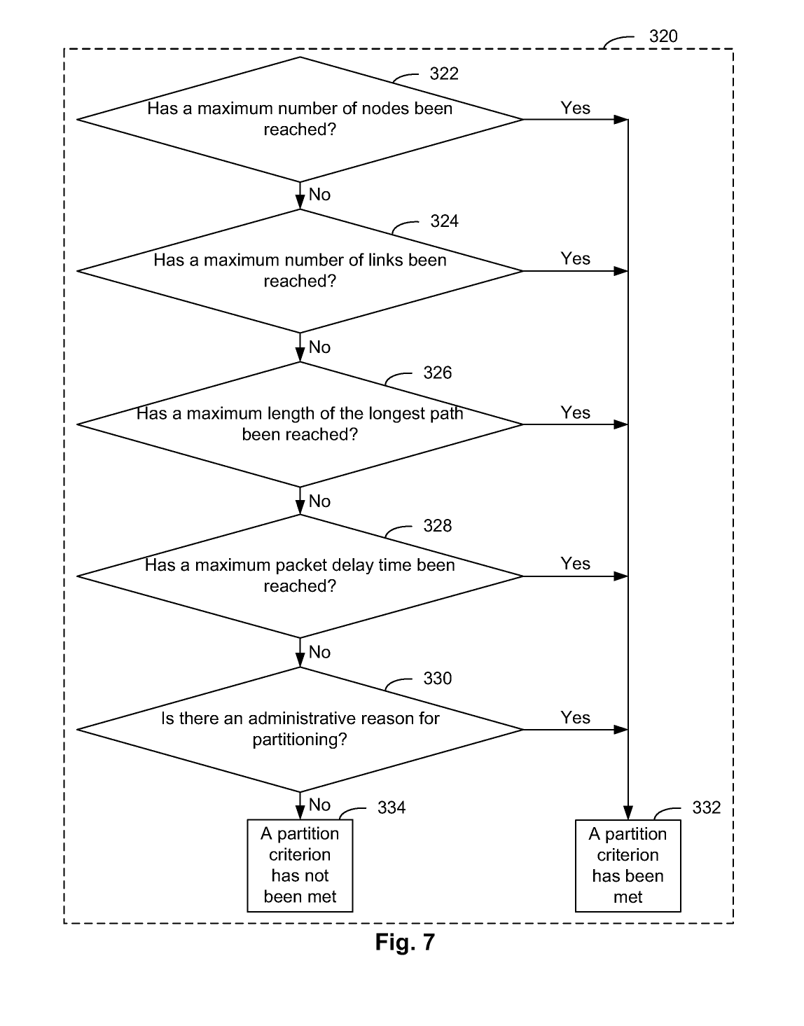

With respect to whether a partitioning criterion has been met 320, FIG. 7 illustrates a flow chart for determining whether or not to partition a network into multiple cells. It can be determined whether the number of nodes in the network has reached a maximum number of nodes 322. For instance, the maximum number of nodes in each network or cell can be set to 50. If the network has reached the maximum number of nodes, the partition criterion is then met 332. The network can then be partitioned into multiple cells, such that each cell has less than the maximum number of nodes.

If the network has not reached the maximum number of nodes, it can be determined whether a maximum number of links has been reached 324. If it has, the partition criterion is met 332, and the network is partitioned into multiple cells such that each cell has less than the maximum number of links.

If the network has not reached a maximum number of links, it can be determined whether a maximum length of a predefined longest path is reached 326. The length of the longest path can mean the number of hops from one node to another node in the network. For instance, assuming the maximum length of the longest path is set to four, when the longest path from one node to another node in the network is four or more, then the partition criterion is met 332, and the network is partitioned into multiple cells such that the longest path from one node to another node does not exceed four for each of the multiple cells.

If the maximum length of the longest path has not been reached, then it can be determined whether a maximum amount of time for the largest link delay (e.g., a maximum packet throughput time) is met 328. If a link delay reaches this maximum amount of time, then the partition criterion is met 332. For instance, assuming a maximum amount of time for the largest link delay is set to 1 sec, then any link that meets or exceeds this threshold can be severed. The nodes that formed that severed link are placed in one or more different cells.

If none of the above partition criteria is met, then it is to be determined whether there are other criteria based on administrative concerns that are met 330. Such criteria can be based on political reasons, security, economic reasons, other reasons, or combinations thereof. If none of the criteria are met, then the network is not partitioned 334.

It is to be understood that the network can be a cell; thus, the implication is that a cell can be further divided into multiple cells if one of the partition criteria is met with respect to that cell. FIG. 7 is illustrative of one of many embodiments for determining whether to partition a network. The criteria for partitioning a network can be checked in any order and can be in various combinations of one or more of the criteria. Furthermore, the criteria for partitioning a network is not limited to the criteria stated above, but can also comprise of other criteria.

If a partition criterion has been met and the network is partitioned into multiple cells, then at least one SN is selected for each cell 360, so that the cells can be interconnected through the SNs.

A SN in a RizoCell can be selected from RNs according to a set of criteria. Some examples of such criteria can be location coordinates of a node, network topology, processing capacity of the node, handover capability, service profile, service availability, performance level, routing metrics, accounting and billing policy, and some other administrative policy.

In an embodiment of the present invention, a SN can be selected based on two generalized selection criteria. The first selection criterion is determining which node is the “healthiest” amongst the nodes in a cell. Health can be based on the following criteria: (1) bandwidth of each node to the Internet, GSM, PSTN, or other networks; (2) bandwidth of each node to other nodes in the cell; and (3) the processing power of each node, the storage space of each node, and other characteristics of each node.

The second selection criterion is determining which node has the most strategic location amongst the nodes in a cell. Since the cell topology is known, an average distance vector to other nodes within the cell is calculated for each node in the cell. The node with the shortest average distance (or fastest speed) is the most strategic since, generally speaking, that node has a central location to other nodes within the cell. The average distance for each node to the other nodes can be calculated by an arithmetic average, a geometric average, or by other averaging algorithms.

In using an arithmetic average, the distance to other nodes from a node are summed together, and then divided by the number of other nodes (n). For instance, if a node has three neighboring nodes (i.e., n=3) with respective distances of 10, 20, and 15, then the arithmetic average for that node is (10+20+15)/3=15. The arithmetic average distance to other nodes is calculated for each of the other nodes. The node with the smallest average is identified as the most strategic.

In using a geometric average, the distance to other nodes (n) from a node are multiplied together, then the n-root is performed on the product of the distances to the other nodes. For instance, if a node has three neighboring nodes (i.e., n=3) with respective distances of 10, 20, and 15, then the geometric average is

$$\sqrt[3]{10 * 20 * 15} = 14.42 .$$

The geometric average distance to other nodes is calculated for each of the other nodes. The node with the smallest average is identified as the most strategic.

In addition, other averaging algorithms can be used to determine the most strategic location for a SN, where other factors besides physical distance from one node to other nodes are taken in account (e.g., signal strength to other nodes, connection type to other nodes, the number of hops to other nodes, bandwidth to other nodes, handover capability of a node, service profile, service availability, performance level of a node, routing metrics, accounting and billing policy, and some other administrative policy and so forth).

The nodes in a cell can be listed in order of being the healthiest and the most strategic. The node at the top of this list can be selected as the primary SN of the cell. The second node in this list can be selected as the secondary SN. The following nodes in the list can be backup SNs in the event that the primary SN, the secondary SN, or both, fail.

Once one or more SNs for a cell are selected, the one or more SNs of one cell can be connected to the one or more SNs of other cells via network tunnels. The network tunnels can be setup through a backbone network (e.g. the Internet, a cellular network, PSTN, or other backbone networks), optical fiber cables, satellite link, or other transmission means. A special protocol can be designed to maintain the connectivity among the SNs. Each SN maintains the network topology for the RizoCell, and serves as the default gateway router for routing traffic for RNs in the RizoCell. Each SN can also be connected via a network management protocol such as SNMP to a centralized Network Management System (NMS) of the RizoNet.

Once one or more SNs are selected for a cell, network tunnels (e.g., vertical links) are established to interconnect the various cells 380. The network topology for the various cells can be selected based on various network topologies.

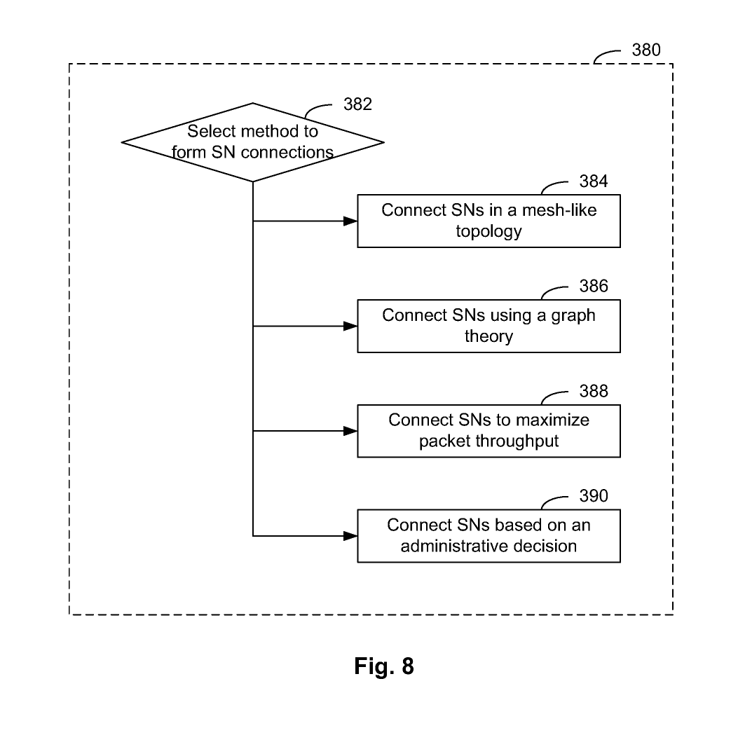

FIG. 8 illustrates a flow chart for selecting a network topology for interconnecting cells. The SNs can be connected in one or more of the following ways: (1) in a mesh-like topology 384; (2) using a graph theory 386; (3) taking into account network characteristics to improve the efficiency of the network (e.g., to maximize packet throughput) 388; and (4) other methods of arranging the SNs 390 (e.g., based on administrative decisions including but not limited to business reasons, security, economic reasons, or other reasons).

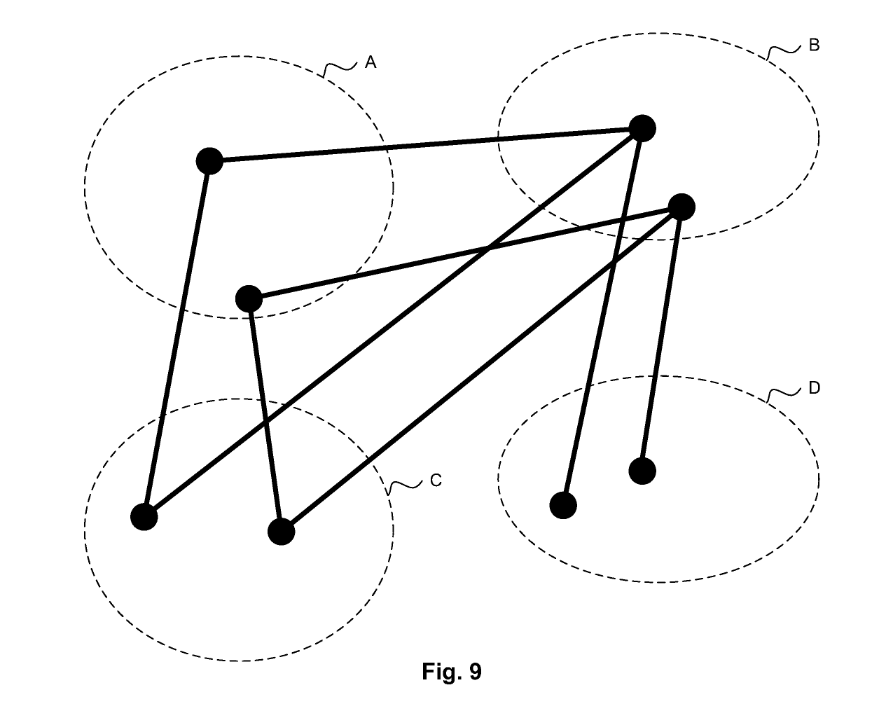

For instance, FIG. 9 illustrates a network view of cells connected with each other in a mesh-like topology. Cells A, B, C, and D are randomly connected in a mesh-like topology via each cells respective SNs, where each cell has two SNs, a primary SN and a secondary SN.

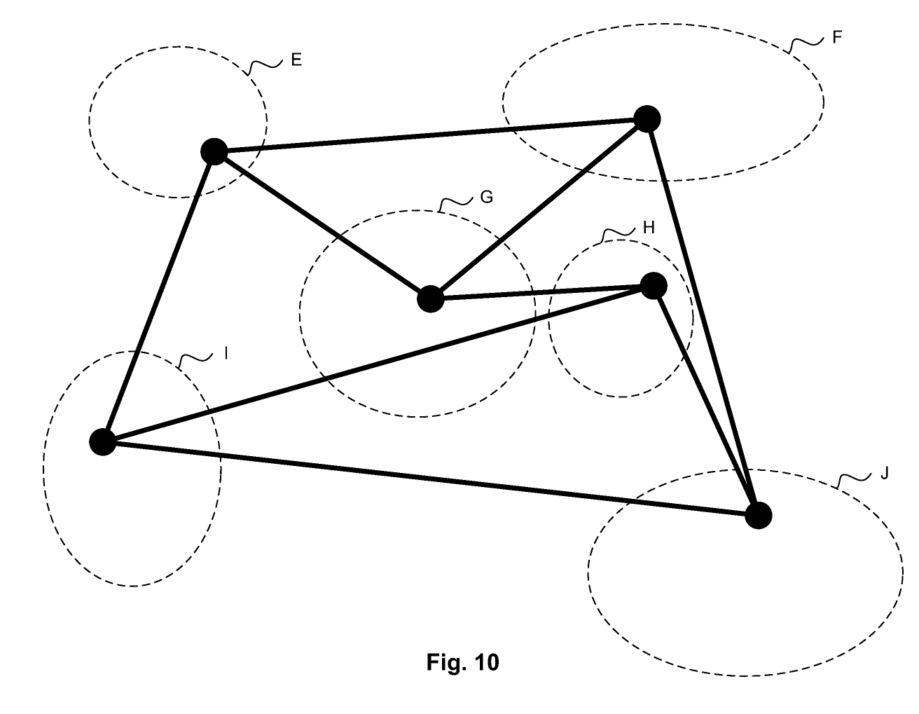

FIG. 10 illustrates a network view of cells connected with each other using a second degree regular graph topology. Cells E, F, G, H, I, and J are connected with each other using a third degree regular graph topology, where each cell is connected to exactly three other cells. This is but one example of the many various graph theories that can be used to connect various cells.

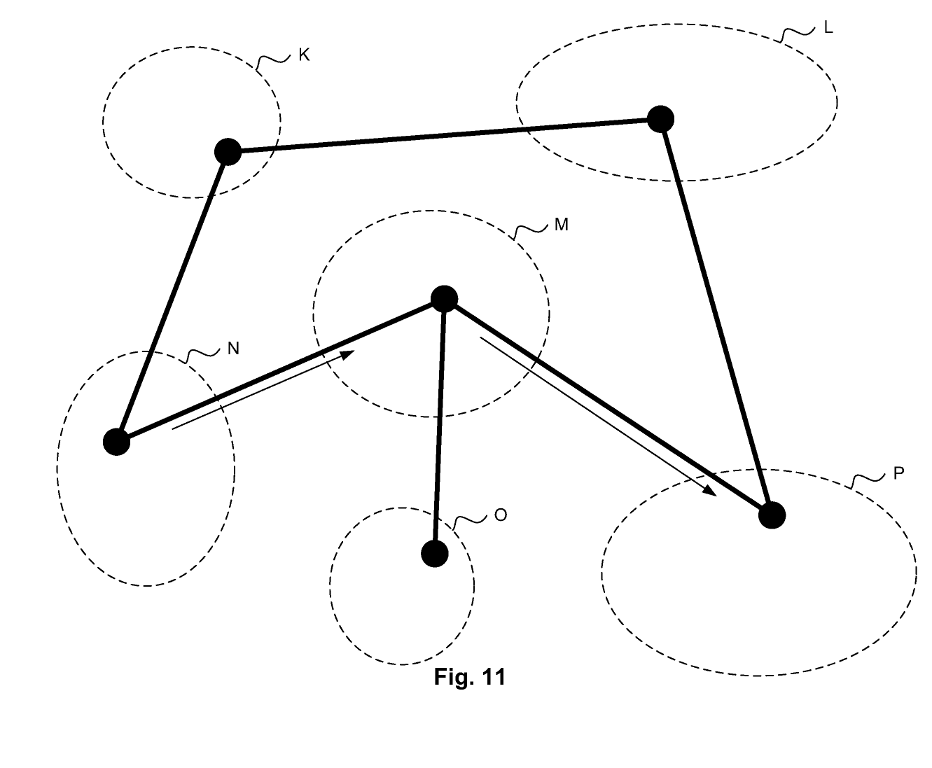

FIG. 11 illustrates a network view of cells connected with each other taking into account network characteristics. Cells K, L, M, N, O, and P are connected with each other to maximize packet throughput. It can be appreciated by one in the art that any number of metrics can be used to improve the overall efficiency of a network, therefore maximizing packet throughput is but one of many network characteristics that can be used in selecting which cells to connect with each other.

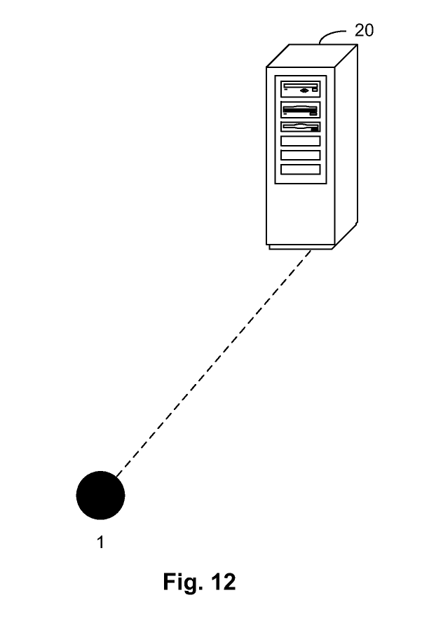

FIGS. 12-16 are network views of a RizoNet to illustrate an example of the evolution of the RizoNet with respect to network formation and cell partitioning. FIG. 12 illustrates a network view of a node joining a RizoNet of the present invention. In this example, node 1 searches for nearby nodes to join a mesh network with nodes in its vicinity. However, since node 1 is the first node in its vicinity, no other nodes are nearby to connect with it. Node 1 registers itself with a design server 20, so that the design server 20 can keep track of the network topology and manage the network.

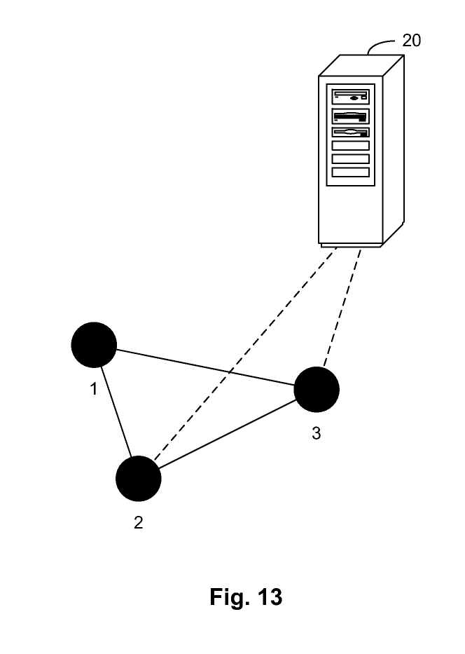

FIG. 13 illustrates a network view of a second node, node 2, and a third node, node 3, joining a RizoNet of the present invention. Node 2 searches for other nodes in its vicinity to join the mesh network. It detects node 1, and connects with node 1 to establish a link between node 1 and node 2. Node 2 also registers itself with the design server 20 and reports the link between node 1 and node 2. Node 3 joins the network and detects nodes 1 and node 2. Node 3 follows the same steps as node 2 by establishing links with the neighboring nodes and reporting information to the design server 20.

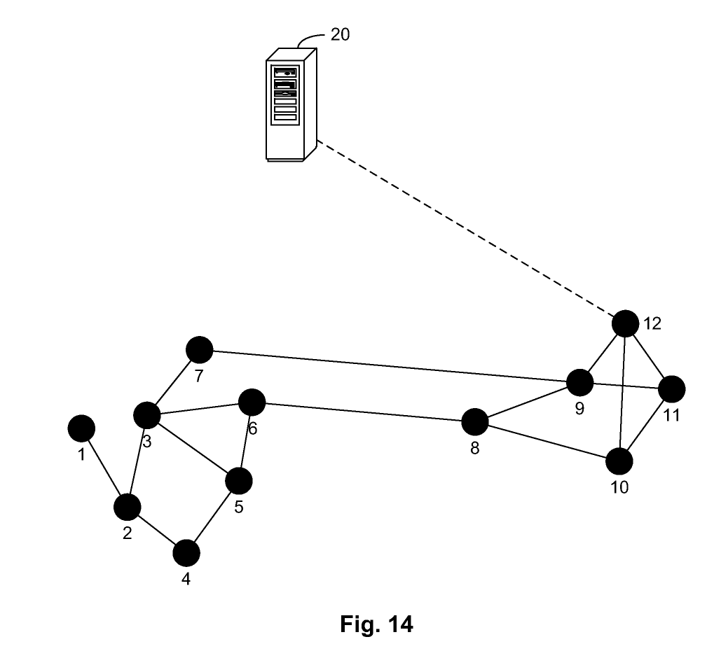

FIG. 14 illustrates a network view of a RizoNet with 12 nodes. As more nodes join the RizoNet, the RizoNet can grow very quickly. Here, a node, node 12, searches for nearby nodes, and connects to its neighboring nodes (i.e., nodes 9, 10, and 11). Node 12 forms a link with these nodes, then registers and reports the links to the design server 20.

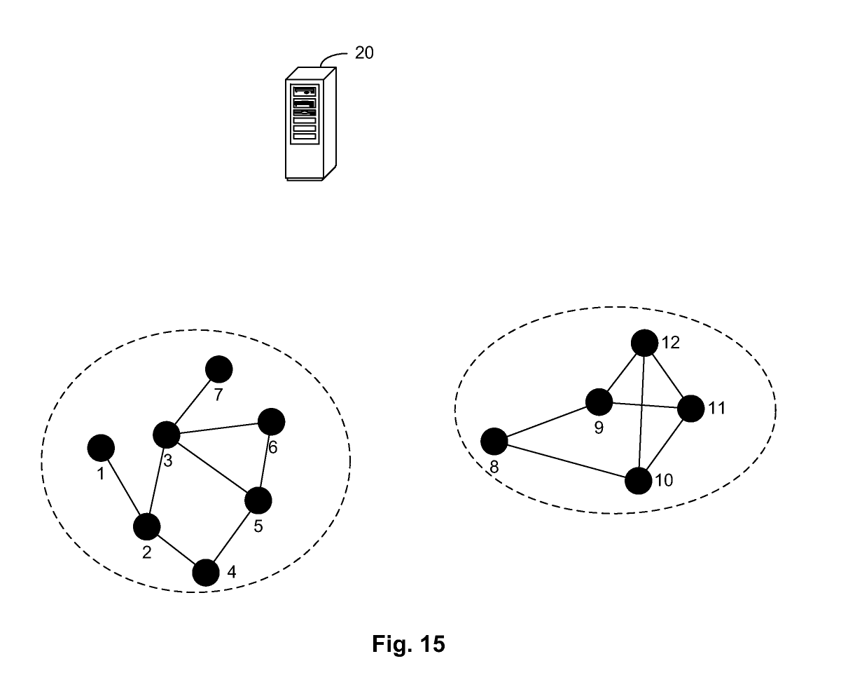

FIG. 15 illustrates a network view of a RizoNet that is partitioned into two cells. The design server 20 determines whether a partitioning criterion is met. If so, the design server 20 selects the nodes to group together into a cell. The design server 20 can select nodes to group together based on geographical proximity of the nodes, bandwidth of the nodes, connection types of the nodes, the number of nodes, the number of links in each of the new cells, maximum length of the longest path in each of the new cells, administrative decisions, and other factors to maximize the efficiency of the RizoNet. Once the nodes for each cell have been selected, then the original links between nodes that are now with different cells are severed. For instance, referring to FIG. 14, the link between nodes 6 and 8 is severed, and likewise the link between nodes 7 and 9 is severed.

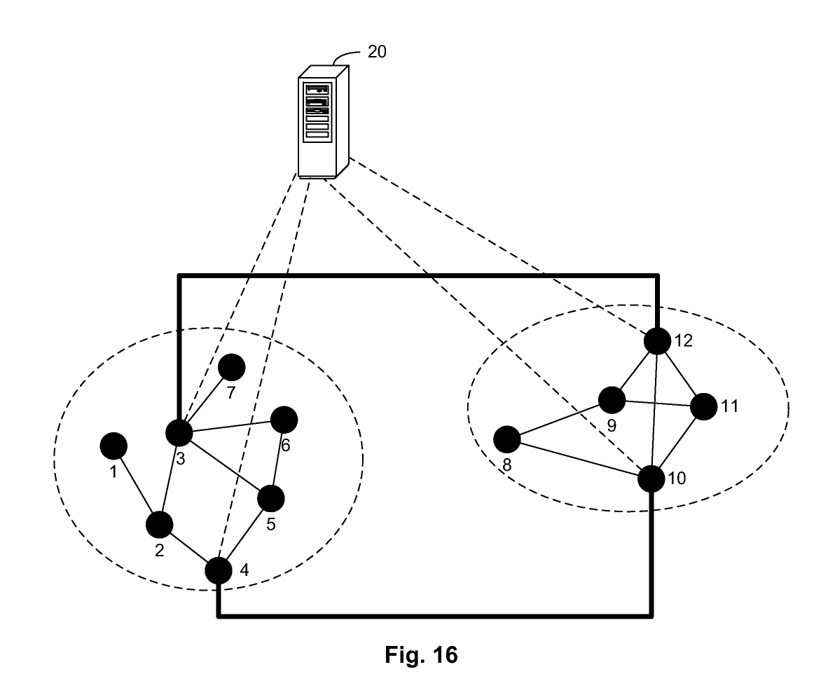

FIG. 16 illustrates a network view of a RizoNet, where a network tunnel connects the cells of the RizoNet. Once the cells have been established, at least one node in each cell is selected as a SN to connect to other cells. The one or more SNs of a cell are then connected to SNs in other cells via a backbone network. The topology of the SNs' connection can be chosen based on a mesh-like topology, a graph theory, an algorithm to optimize network performance, administrative reasons, or any other method.

As stated earlier, each RizoCell has at least one RizoNode as a SN. The SN acts as a gateway for the RizoCell to connect to other RizoCells and existing networks of the RizoNet.

In principle, a RizoNode can have multiple horizontal links (e.g., wireless links) to connect to multiple neighboring RizoNodes (e.g., nodes within the wireless coverage of the RN).

A routing computation algorithm can be designed to compute one or more paths from a source RizoNode to a destination RizoNode. A path can comprise a sequence of nodes, called hops, from the source RizoNode to the destination RizoNode. The links connecting the sequence of RizoNodes can be a hybrid of wireless links, wired links, network tunnels, or combinations thereof.

Among the multiple paths selected, one path is called the primary path that is used as the default routing path, and the next RizoNode from the starting RizoNode in the primary path is referred to as the default next hop (or just “next hop”). All the other paths are referred to as backup paths in order of priority. When the primary path is not available (e.g., due to the link or node breakdown along the path), the first backup path can become the primary path, and if the first backup path is not available, the second backup path can become the primary path, and so on and so forth.

A node discovery and routing protocol with a path computation algorithm is designed to determine next-hops and end-to-end paths. The path computation algorithm can be a QoS-based shortest-path routing algorithm (including open shortest path first (“OSPF”) routing protocol, border gateway protocol (“BGP”), or other routing algorithms), which can compute the next-hops and the end-to-end for one or multiple shortest paths between any pair of nodes in the network.

For a given RizoNet, horizontal (wireless) links can be determined based on the connection type (e.g., wireless coverage of a RN). Vertical links (e.g., IP tunnels between SNs, and dedicated trunks between two IW-Gateways for two RizoCells) can be determined based on the SN selection and RizoCell partition algorithms.

With respect to a path computation algorithm, each link is assigned with a “distance” which is based on the performance metrics (e.g., bandwidth and delay, stability of the link, etc.) and administrative metrics (e.g., type of the link, location of the link, cost of the link, etc.). In an embodiment of the present invention, a SN in a RizoCell can run a path computation algorithm to compute paths from each of the RizoNodes in the RizoCell to every other RizoNode in the network. The SN stores the paths and distributes the paths to corresponding RizoNodes in the RizoCell for packet forwarding. The paths are re-calculated and updated by the SN when the network conditions changes (such as when a new RizoNode joins the RizoCell, when a link is down, etc.). Every RizoNode maintains the latest network topology view and pre-calculated paths to every other RizoNode in the RizoNet.

The path computation algorithm considers both the horizontal links and vertical links in the network topology. In some embodiments, for a path within a RizoCell, the path computation algorithm may mainly consider horizontal links for the intra-RizoCell path, while for a path crossing over multiple RizoCells, the path computation algorithm may consider vertical links for the inter-RizoCell path.

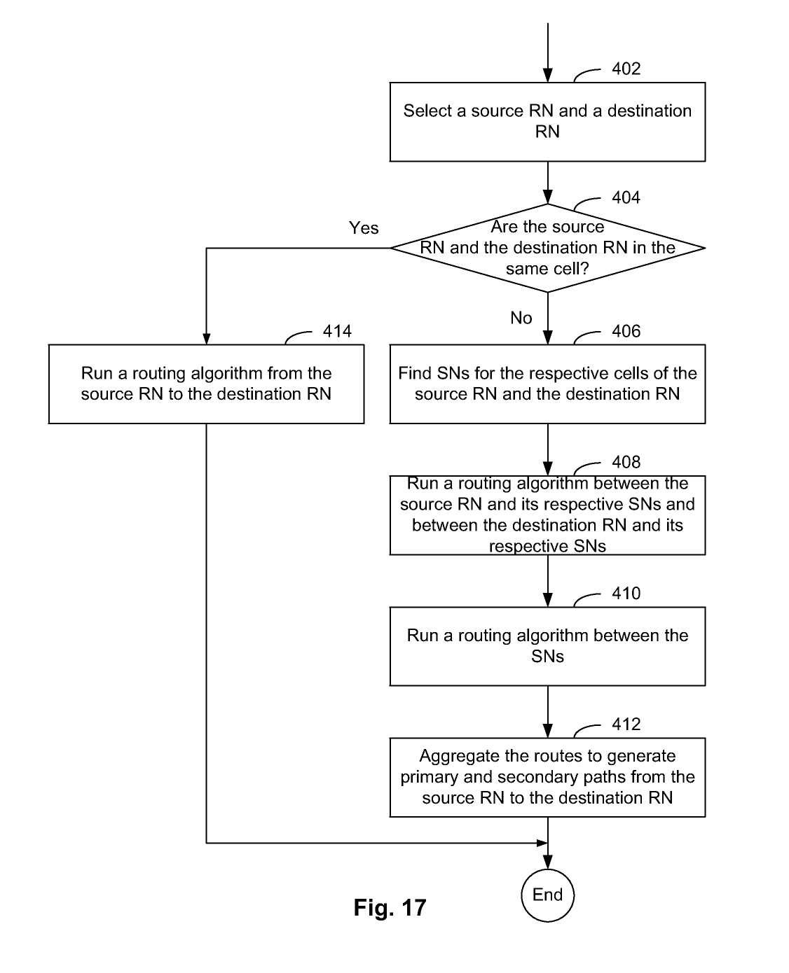

FIG. 17 illustrates a flow chart for a path computation algorithm for use in a RizoNet of the present invention. A source RN and a destination RN are selected to calculate a path from the source RN to the destination RN 402. Next, a determination can be made if the source RN and the destination RN are in a same RizoCell 404. If the two nodes are in the same RizoCell, then a routing algorithm is performed over the cell from node 1 to node 2, 414, to calculate a primary path and secondary paths.

If the two nodes are in different cells, then a SN is found for each respective cell of each node 406. Next, a routing algorithm is performed from each node to its respective SN 408. Additionally, a routing algorithm is performed from one SN to the other SN over the network topology 410. Finally, the calculated path information from the various segments between the source RN and the destination RN are aggregated to find the end-to-end primary path and secondary paths 412.

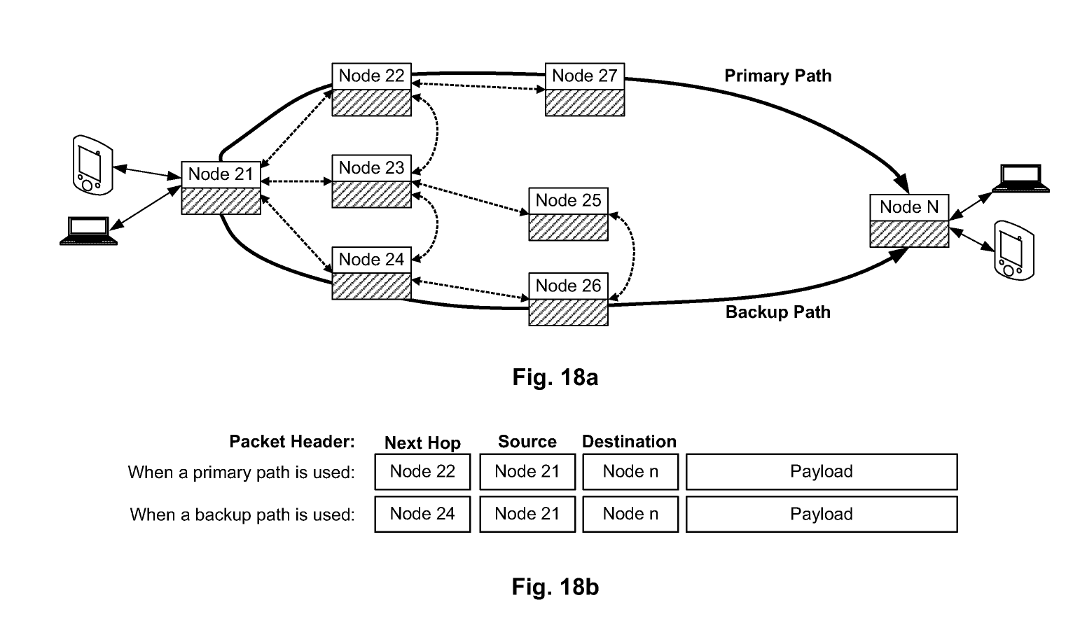

FIGS. 18a-18b illustrate a result of a path computation algorithm for routing a packet from a source node, node 21, to a destination node, node n. A node 21 has neighboring nodes 22, 23, 24 within its wireless range. From the path computation algorithm, the path (node 21, node 22, node 27, . . . , node n) is the primary path, while the path (node 21, node 24, node 26, . . . , node n) is the backup path.

With respect to the primary path, the node 21 transmits a packet to the node n by first transmitting to its neighboring nodes with the node 22's address as the next-hop address in the packet header. Although the node 22 is the intended next hop for the packet, the packet nevertheless reaches the nodes 22, 23, and 24 since these nodes are the neighbors in the wireless range.

When the node 22 receives the packet, it checks the packet header and finds itself the intended receiver, so it takes the packet and checks the destination address of the packet that is the node n's address. Thus, the node 22 puts a node 27's address as the next-hop and retransmits it to reach the node 27 as the intended receiver toward the node n. When the nodes 23 and 24 receive the packet, they check the packet header and find they are not the intended receivers, so the nodes 23 and 24 discard the packet. Note that the nodes 23 and 24 do not broadcast the unintended packet any further in the network.

For this communication session, among all the neighbors for the node 21, the node 22 is active while the nodes 23 and 24 are inactive in the network topology for routing this particular packet. If the primary path is not available for some reason, the backup path now becomes the primary path. Now the node 21 puts the node 24's address as the next-hop address in the packet header, and upon receiving the packet, the nodes 22 and 23 will discard the packet since they are not the intended receivers. However, the node 24 will process the packet, and put the node 26's address as the next hop. The node 26 can then retransmit the packet to reach a node 26 as the intended receiver toward node n. In this way, the packet can be received and retransmitted until the destination node n has received the packet.

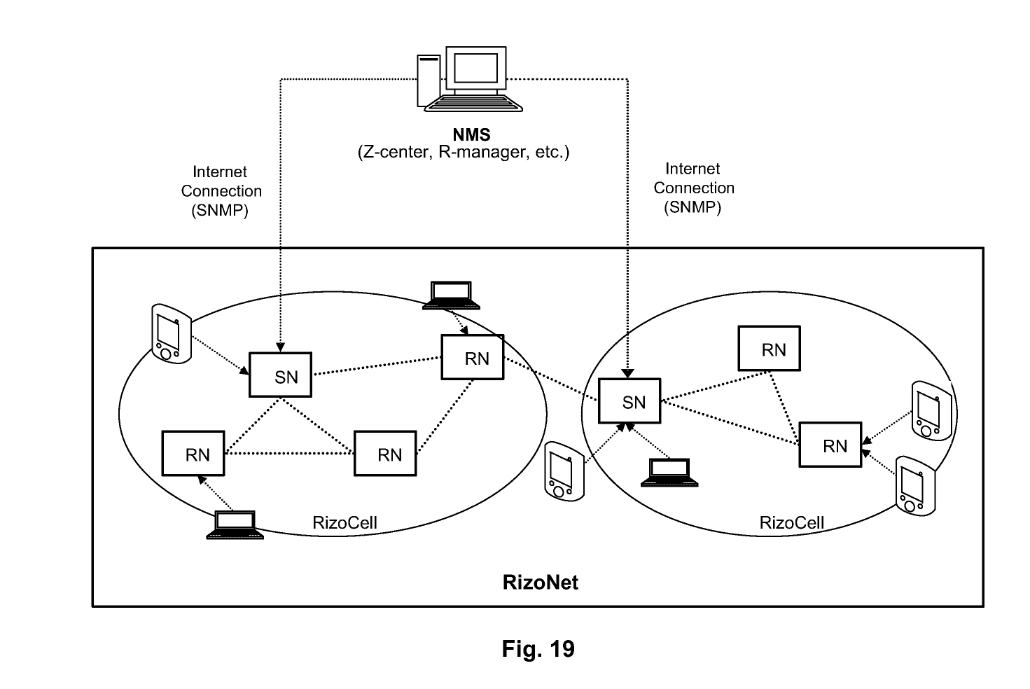

FIG. 19 illustrates an embodiment of the network management system (“NMS”) of a RizoNet of the present invention. A Z-Center comprises a server or a set of servers running a management software called R-Manager for managing nodes (e.g., SNs and RNs) in a RizoNet over the Internet (or other networks). The Z-Center can also be referred to as a design server or a management server. The Z-Center can access SNs via Internet access from the subscribing sites where the SNs reside, then access other RNs from the SNs via horizontal links (e.g., wireless connections). Additionally, the Z-Center can directly manage nodes by connecting to nodes via the Internet or other networks connected to the nodes.

In some embodiments, a management protocol such as simple network management protocol (“SNMP”) is designed to communicate between the Z-Center and RizoNodes for management. In some embodiments of the NMS, the Z-Center can provide a full range of general FCAPS management functions, including fault management, configuration management, accounting management, provisioning management, and security management, to manage all the RizoNodes in the RizoNet.

In particular, Z-Center provides the functions for RizoNode authentication and registration, enabling or disabling a RizoNode, SN assignment whenever needed (over-writing a RizoNode's self-initiated assignment algorithm in a RizoCell), and enabling RizoNodes for other tasks/applications (e.g., content distribution, grid computing, and other applications).

Access to the RizoNet can be limited to authorized nodes or provided to any node. Each RizoNode can be assigned a node identification number (“node-ID”) before the RizoNode is installed in the network. When a RizoNode is installed by the user at the user's site, the initialization program of the RizoNode will automatically set up an IP connection to the Z-Center to register itself. Upon successful registration and authentication by the Z-Center, the RizoNode is assigned an identifier (such as its own IP address, a SN IP address in the RizoCell it resides, or other identifiers) and can begin exchanging messages with its neighbors and SNs in the RizoCell.

Each RizoNode in the network can filter traffic and can discard access rights through the RizoNode. The basic authorization can be based on either the authentication between any two nodes or their respective authentication with the Z-Center. Anonymous nodes may join the RizoNet with accepted authorization certificates.

A user can register to access the RizoNet by initiating a registration process with a RizoNet and getting an ID assigned. With the user ID assigned, the user can access the RizoNet from any RizoNode in any place within the RizoNet's coverage.

Furthermore, in some embodiments, the Z-Center may include other special servers to manage other services. For example, registration and fall-back servers may be provided to enable a peer-to-peer content distribution network. Some application servers may be provided to enable location-based services, and resource management servers may be provided to enable a grid computing network.

In some embodiments of the RizoNet, the Z-center can monitor the RizoCells via the reports sent by SNs in a RizoCell. For instance, a SN can query the RNs in its respective cell and gather information with respect to each RN, including the health and status information of that RN. If the SN cannot reach a node, then the SN will report to the Z-Center that the unreachable node is not available. The information gathered by the SN is then reported back to the Z-Center. In this way, the Z-Center can track the network topology of the RizoNet, and disseminate that network topology to the SNs of the RizoNet.

The Z-center can also manage network formation, partitioning of the network, selecting SNs, network tunnel creation between cells, and network reconfiguration and optimization as stated above.

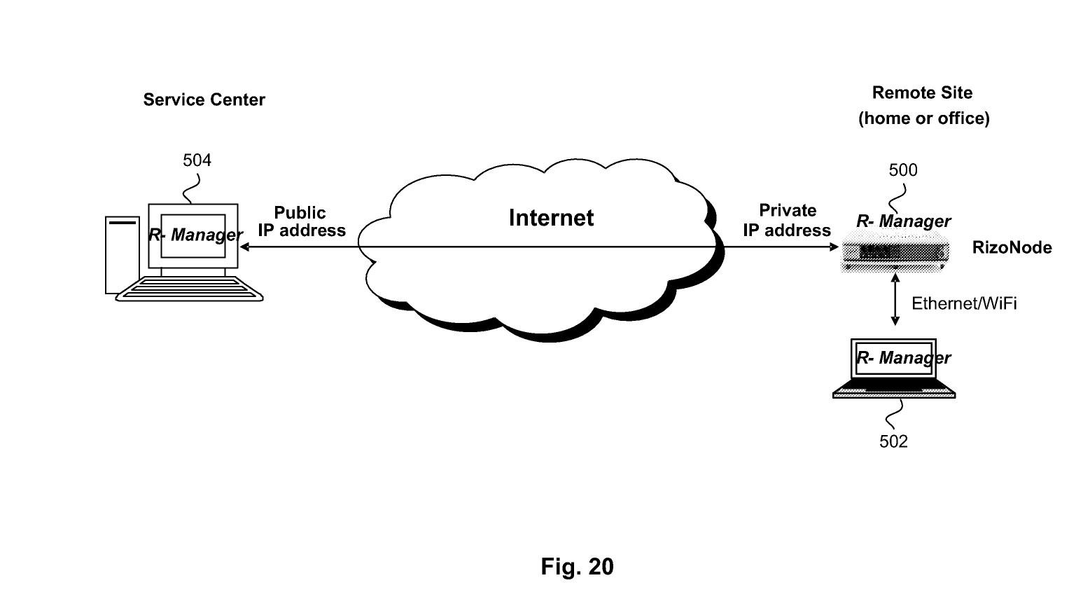

A RizoNode can be managed remotely or locally via software, herein referred to as an R-manager (or a remote manager). FIG. 20 illustrates an R-manager running on a management server, a RizoNode, and a configuration terminal for the RizoNode. An R-manager can run on a configuration terminal 502 for local management of a RN 500, and can also run on a management server 504 for remote management of the RN 500. The R-manager can also run on the RN 500 for element management and for communicating to other devices running an R-manager.

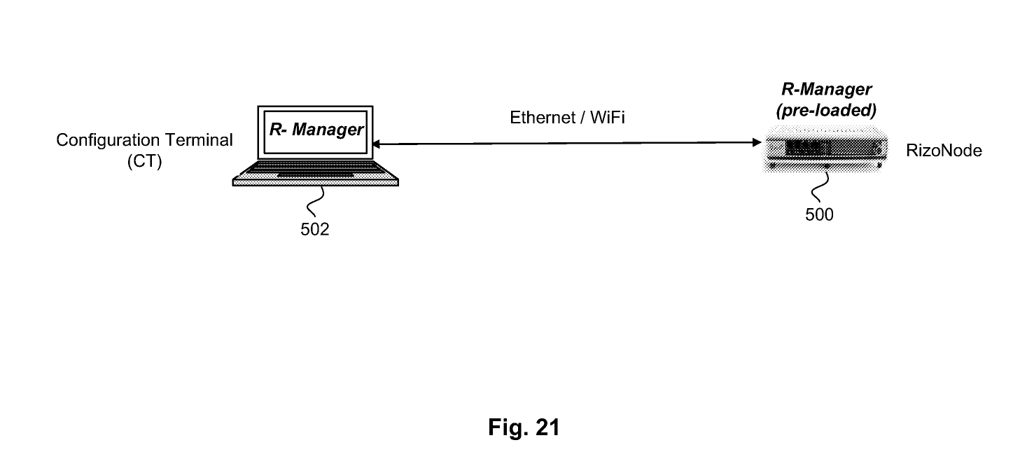

FIG. 21 illustrates an R-manager running on a configuration terminal that is locally connected to a RizoNode. The RN 500 and the configuration terminal 502 can be connected via an Ethernet connection, a WiFi connection, or other type of local connection. The configuration terminal 502 is loaded with an R-manager for communicating with the R-manager that is preloaded on the RN 500.

The R-manager allows a user to locally and remotely run management operations on the RN 500. Management operations can include the following: (1) setting up a network connection, which can include inputting a DNS sever, a proxy server, or an IP address; (2) setting up a fixed lined and mobile phone connection, which can include inputting a local landline number or mobile phone number and setting up dialing rules; (3) setting up Bluetooth (“BT”) connections, which can include pairing with BT devices; (4) advanced setup features for system administration, process management, file access, operating system access, security, and other purposes; and (5) other installation and configuration operations.

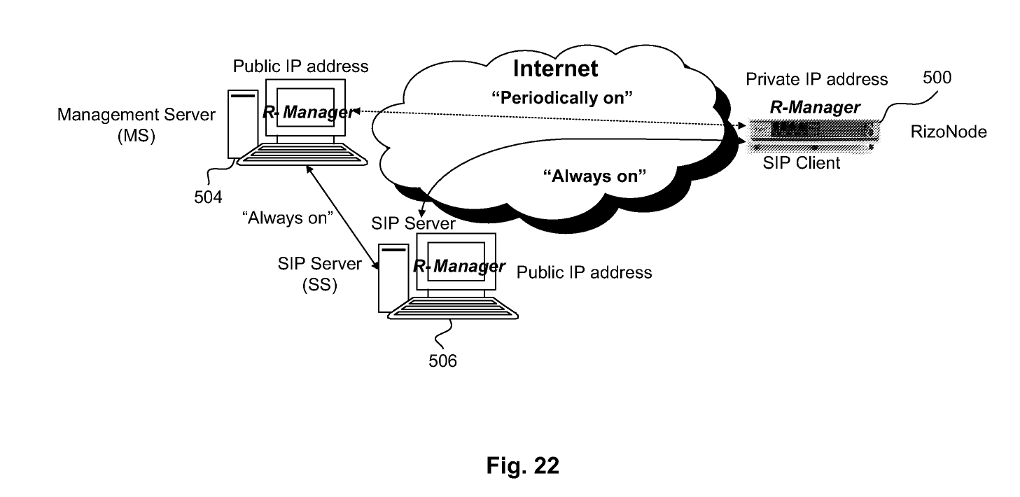

FIG. 22 illustrates an R-manager running on a management server that is remotely connected to a RizoNode. The RN 500 can be preconfigured with public IP addresses for the management server 504 and for a session initiation protocol (“SIP”) server 506, such that the RN 500 can send “keep-alive” messages to the management server 522 periodically. If the management server 504 does not receive the keep-alive messages within a predefined amount of time, then the RN 500 is declared out of service.

When the RN 500 connects to the management server 504 for management operations, the R-manager of the RN 500 can establish a management session with the R-manager of the management server 504. Once a connection is established, the management server 504 can remotely control the management operations of the RN 500.

When the management server 504 accesses the RN 500, the management server 504 proxies the SIP server 506 to make a “management” call to the RN 500 via an established SIP session which is per SIP protocol. The RN 500's R-manager is then triggered by the management call and starts a management session with the R-manager of the management server 504. Once the connection is established, then the management server 504 can remotely control the management operations of the RN 500.

### RizoNode

Generally speaking, a RizoNode can be a plug-and-play gateway switch deployed at a user site, and can be deployed at a user site when a user subscribes to a service offering via the RizoNet.

The RizoNet can provide a wide range of voice (e.g., VOIP), data (e.g., text, music, video, and other data), network (e.g., peer-to-peer, content distribution, grid computing, and other applications), and home-networking services.

In some embodiments, the present invention provides a gateway switch system for wired and wireless communication. The gateway switch is typically deployed at a service subscriber's site (home or office) to enable services that can be provided by the gateway switch and to allow the gateway switch to provide services; hence the deployment of the gateway switches is dependent on the type of services subscribed to and the location of the service subscribers.

The transmitting and/or receiving devices can comprise one or more of the following: a cellular mobile module, a local area networks module, a wireless local area networks module, a cable modem module, a satellite module, a BlueTooth module and a landline PSTN module.

In some embodiments, the user-specific rules can comprise forwarding rules based on a wireless voice service plan of a user, user specified rules, and other rules. Furthermore, user-specific rules indicate a user-specific priority of the processed data for transceiving data using one or more specified transceiving modules based on the user-specific priority.

In some embodiments, the service-specific rules can comprise forwarding rules based on a mobile voice and/or data service plan of a user. In some embodiments, the service-specific rules can comprise forwarding rules based on a landline telephone voice and/or data service plan of a user. In some embodiments, the service-specific rules can comprise forwarding rules based on an Internet voice and/or data service plan of a user. In some embodiments, the identifier comprises a landline phone number, a wireless phone number, an IP address, a VOIP account ID, or a combination thereof.

In some embodiments, the present invention provides a method of communication, comprising (a) receiving data or voice signals from a transmitting device, (b) designing an identifier to the voice and/or data signals, and (c) forwarding the voice and/or data signals to a receiving device according to user specific rule.

In some embodiments, the present invention provides a service enabling point to the existing networks of mobile, the Internet, cable, PSTN, and public wireless (e.g., WiFi/WiMax). The present invention also serves effectively as a distributed network demarcation point among these existing networks.

In some embodiments, the present invention enables voice services (such as VOIP for mobile and landline phones), value-added network services (such as peer-to-peer content distribution, distributed grid computing for network utility services), and home-networking services (such as household consumer electronic device control, management, and security surveillance).

In some embodiments, a communication system including a gateway switch described herein can be used to enable the following mobile and landline VOIP services and data services as described below.

As used herein, the term “gateway switch” is sometimes referred to as, and can be used interchangeably with gateway communication switch, gateway communications switch, service switching and control device, node, or RizoNode. The terms not specifically defined herein are within the knowledge of an ordinary artisan.

In some embodiments, a communication system including the gateway switch described herein can allow universal mobile communication without roaming, regardless of whether it is domestic or international call.

In some embodiments, the communication system including a gateway switch described herein allows one to provide value-added network services. Such value-added network service includes, for example, peer-to-peer IP services that can include voice, data, video content distribution or location-based services that can include commerce, advertising, education, etc.

In some embodiments, the communication system including a gateway switch described herein allows one to provide network utility services. Such network utility service can include, e.g., grid supercomputing for commercial and scientific purposes.

In some embodiments, the communication system including a gateway switch described herein can allow one to provide home-networking services such as household consumer electronic device control, management, security surveillance, and the likes.

A RizoNode can connect to the Internet, a mobile network (such as GSM, CDMA, CDMA2000, WCDMA, TD-SCDMA, and 4G-mobile), a public wireless network (such as WiFi, WiMax, etc.), a cable network, PSTN, and other networks. Once connected, the RizoNode can access these networks and switch traffic between these networks. Some functions of a RizoNode can include connecting to above-mentioned different networks to allow a mobile handset (such as a mobile phone, PDA, handheld computer, iPod, etc.), a landline phone, or a PC to access the services from the networks. This makes a RizoNode a service enabling point to the existing networks of mobile, the Internet, cable, PSTN, public wireless, and other networks.

Other functions of a RizoNode can include switching between these different networks for service interworking. Such switching can include, e.g., switching from a mobile network to a PSTN, from a WiFi/WiMax network to a PSTN, from a mobile network to a cable network, from a WiFi/WiMax network to a cable network, from a mobile network to the Internet, from a WiFi/WiMax network to the Internet, and data path switching/interworking (e.g., connection termination, encapsulation and initiation) and control path signaling/interworking (e.g., address translation, connection path calculation and connection status maintenance). In effect, a RizoNode is a distributed network demarcation point among these existing networks.

In a conventional network infrastructure, a network demarcation point is typically centralized and established between two or more networks by peered service providers under certain network peering agreements to enable end-to-end services across different networks managed by different service providers. The RizoNode, however, can be located at a subscriber's site; thus providing a distributed network demarcation point for network and service interworking pertaining to the services enabled at the subscriber's site.

Further functions of a RizoNode can include, e.g., connecting to other RizoNodes through WiFi/WiMax connections or Internet IP tunnels, thus the RNs can form an ad-hoc mesh network, which can additionally include, e.g., authentication/security, signaling, and routing to form a self-contained universal access network of RizoNodes.

As illustrated in FIG. 3, the gateway switch can include any or all the following modules and interfaces for connecting to different networks: a cellular mobile module, a PSTN module, a cable module, a LAN module, a home-networking module, a wireless module, a switching module, a system control module, a data storage module, and other modules.

A cellular mobile module can receive and transmit cellular mobile signals, and can operate on any of the following cellular mobile standards: GSM/GPRS (850 MHz/900 Mhz/1800 MHz/1900 MHz), CDMA, CDMA2000, WCDMA, TD-SCDMA, and other cellular standards. The cellular mobile module can provide both a digital (e.g., PCM) voice interface and an analog voice interface with an analog voice output interface, where the output interface may include a handset, a headset, and/or alerts. Lastly, the cellular mobile module can provide RS232 and USB control interfaces for interconnecting other modules. In summary, this module provides an interface for connecting to cellular mobile networks.

A PSTN module can connect to a phone line and/or a telephone station. The PSTN module can include a PCM codec chip and a controller chip. Furthermore, the PSTN further can provide a USB control interface for interconnecting other modules, and can provide at least one RJ11 jack for telephone line connections. In summary, this module provides an interface to connect to a landline telephone and to a PSTN.

A cable module can be used to connect to a cable line, and can provide a USB control interface for interconnecting other modules. The cable module can include a PCM Codec chip and a cable controller chip. This module provides an interface to connect to a cable network.

A LAN module can connect to a LAN segment (e.g., a router and a computer) or interface (e.g., a cable modem, an ADSL modem, or other interface) via an Ethernet interface. This provides an interface to connect to an existing LAN or the Internet at the subscriber's site.

A home-networking module can connect to consumer electronics devices over Bluetooth, Zigbee, or other protocols.

A wireless module can be used for a user's wireless access (e.g., WiFi, WiMax, or other wireless connections), and can be used for network interconnection via wireless. The wireless module can comprise of a network adaptor with wireless chipsets based on the WiFi/WiMax standards or other standards which can be configured for wireless access and a wireless network for communications with other wireless modules in other gateway communications switches. The wireless module can also provide a USB control interface for interconnecting other modules. This provides an interface for wireless network access and network interconnection.

A switching module can be used for routing digital voice/data stream between different modules. The switching modules may include a microcomputing unit (“MCU”), a DTMF coding/decoding chip, a multiplexer chip, and RS232 interface chip, and/or provide at least one RJ11 jacks for phone line and telephone set connection. This provides the switching capability for service interworking among the different types of services over the different types of networks.

A system control module can be used to control and manage the gateway system and network formed by the RizoNodes (including functions for network topology, signaling, routing, and management). The system control module can include a CPU, a LAN chip, a multimedia chip, a bois chip, and storage devices (e.g., ram, hard disk drive, or other means of memory storage). The system control module can provide a RS232 and a USB control interface, analog voice interface, and a RJ45 LAN interface. This provides the functionality for the control engine to manage the gateway switch and the network formed by the gateway switches.

A data storage module can be used for memory and data storage (including RAM and a hard disk drive). This provides the memory capability for programs and database storage. Other modules can be added to the RN as needed, or as future innovations in the communications field require specialized modules for communications.

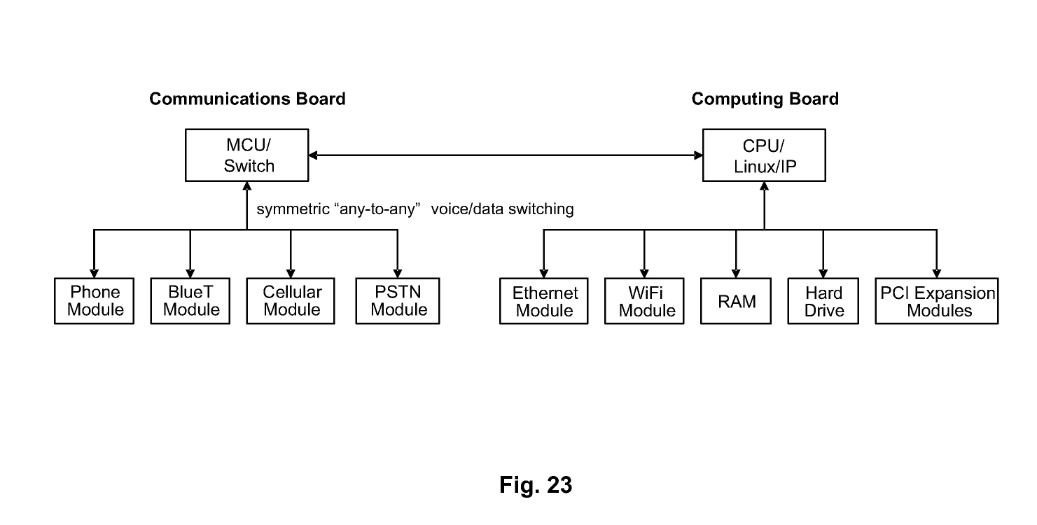

FIG. 23 illustrates a block diagram of a physical layout of an embodiment of the present invention for a RizoNode. Generally speaking, the physical layout of the RizoNode can be separated into a communications board and a computing board. The communications board can comprise various communications modules for receiving and transmitting data, including a phone module, a BT module, a cellular module, a PSTN module, and other modules. These modules are connected to a MCU for symmetric switching between the various modules (i.e. data from a receiver module can be routed for transmission to any other transmission module). The computing board can include one or more of the following: an Ethernet module, a WiFi module, storage space (e.g., RAM, hard disk drive, or other types of memory), a PCI expansion module, and a central processing unit (“CPU”). The computing board can also be referred to as a computing module. The communications board and the computing board can be interconnected via a jump cable, a USB cable, a serial port, an Ethernet cable, or other connections means.

Once a signal is received by a module, the signal can be converted to a digital signal by the module, and then relayed to the CPU via the MCU. The CPU can process the received signal and select a destination module. Based on the protocol of the received signal, the CPU can extract the destination address from the received signal to determine a destination. The computing board can select a module to send information to the destination.

When a signal is received by a communications interface (e.g., phone module, BT module, cellular module, PSTN module, Ethernet module, WiFi module, etc.), the RizoNode can identify a particular communications interface or a set of communications interfaces to symmetrically switch to for sending data (e.g., voice, video, and other information).

For instance, if a phone application receives data via a cellular module, the phone application can route a call from the cellular module based on a service type header in the data received or by preloaded set of service-specific rules. A service type header can be selected by a user of the cellular module to override the default service-specific rules. In addition, if the user does not select to override the service-specific rules, then the service-specific rules can include default rules for routing data for the phone application.

With respect to service-specific rules, the service-specific rules can be selected for an application based on requirements of the application (including bandwidth requirements, QoS, and other application based requirements), user requirements (including cheapest cost to deliver data in terms of monetary cost, bandwidth, or other metrics for cost), availability of a particular routing method (e.g., if a network connection is down), data type of the data to be transmitted or received, and other reasons. Once the service-specific rules are selected, the service-specific rules assign a service-specific priority to each of the transceiving modules for the transmission of data.

Furthermore, data types can include one or more of a security type and a privacy type.

With respect to user-specific rules, the user-specific rules can be implemented by hard-coding a destination port in the received signal, such that the data is switched to that destination port.

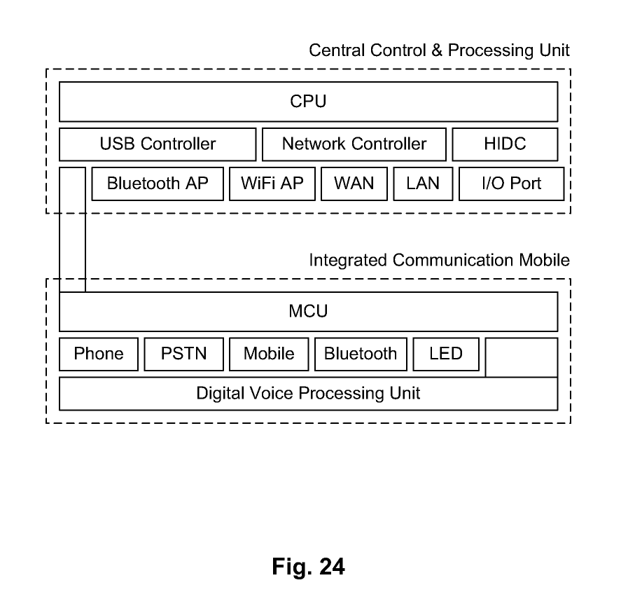

FIG. 24 illustrates a block diagram of a hardware schematic for a RizoNode that supports voice applications. In addition to the components described in FIG. 23, a communications board can further comprise of a digital voice processing unit (“DVPU”). The digital voice processing unit can be a field programmable gate array (“FPGA”) such as a SLIC that can handle the symmetric switching from one communications interface to another communications interface to support voice applications.

When a call is received by a RN from a fixed line phone, a mobile phone, or other device, the DVPU of the RN can extract and capture the destination phone number. The DVPU can switch the call from the received interface and connect to the destination number via one or more communications interfaces. One or more communications interfaces of the RN can be selected to connect to the destination number, where this selection is based on symmetric switching. The connection can be made via the selected network. During this time, the DVPU can be constantly running to support the interconnection between the two interfaces (or potentially more interfaces depending on the application) for transporting data between the caller and the destination of the call.

The RN's service-specific rules may designate that all local phone calls be routed through a landline, or all international calls be routed through an IP network using VOIP. Additionally, the user may override the RN designations by inputting a specific network (e.g., via a cellular network) to route the call.

During the connection process to the destination number, various tones can be played to the caller to inform the caller of the connection status. For instance, when the connection is established and the caller is waiting for the destination to pick up, a ring tone can be played to the caller. Other tones can also be used such as an off tone to convey that the receiver is not connected to the selected network, a busy tone, or other tones to convey other information.

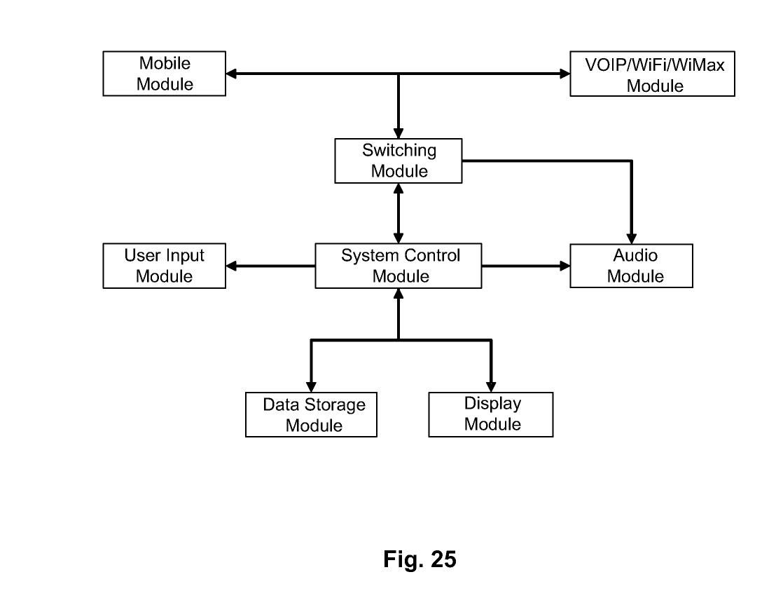

FIG. 25 illustrates a handset architecture for a mobile handset running a program to connect and interact with a gateway communications switch, RizoNode. In some embodiments, the architecture can include any or all of the following modules, a system control module, a switching module, a mobile module, a VOIP/WiFi/WiMax module, an audio module, a user input module, a data storage module, and a display module.

A system control module can be used to control the dialing rule to connect a gateway switch and/or access to a wireless mesh network (e.g., a WiFi wireless mesh network). The system control module can be used for connecting to a selected RizoNode gateway switch and handover from one RizoNode to another RizoNode while traveling through a wireless mesh network formed by RizoNodes.

The switching module can be used to select from two different voice transmission schemes that can include GSM over cellular network or VOIP/WiFi over a wireless mesh network or the Internet.

In some embodiments, a handset especially for the communication system described herein can be realized by upgrading a regular cell-phone or smart-phone with a software program, or can be specifically built to work with the gateway switch.

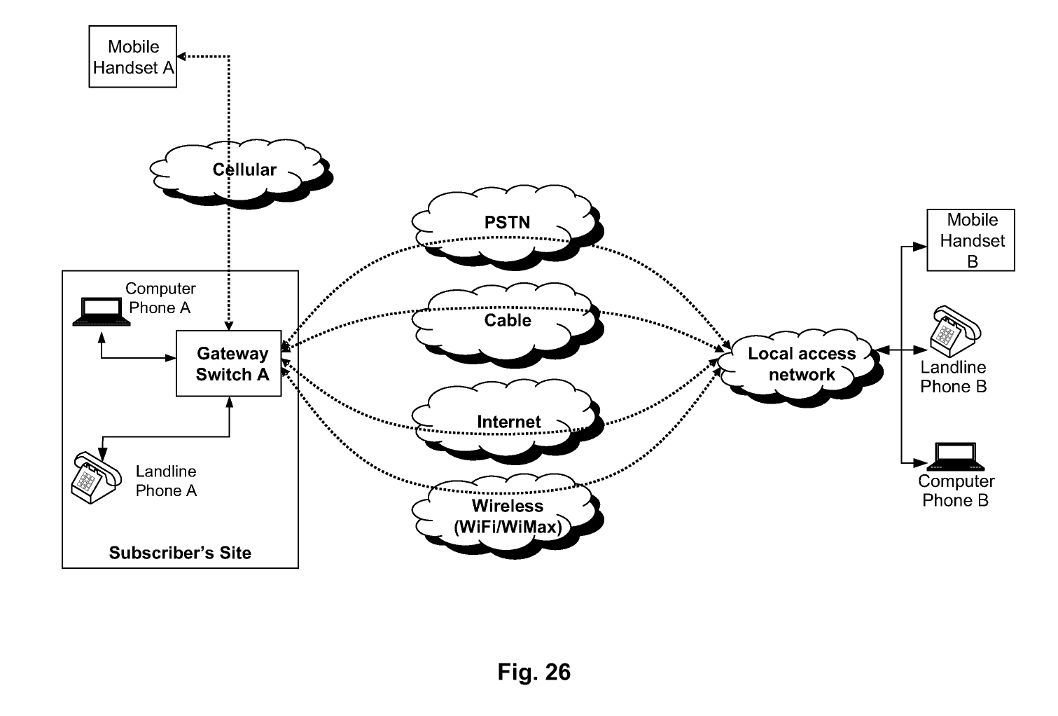

FIG. 26 illustrates a service architecture of a gateway communications switch. A gateway switch A can be installed at a subscriber's site (e.g., a home or an office). The gateway switch A enables the subscriber the capability to access voice and data communications using the gateway switch A from a mobile handset B, a landline phone B, or a personal computer B from a remote location. The subscriber can connect to the gateway switch A via a network (e.g., PSTN, cable network, the Internet, a wireless network) from a remote site, and have the gateway switch A further connect to any other network or device connected to the gateway switch, e.g., a mobile handset A, a landline phone A, or a computer A. The subscriber can in this way access the gateway switch A (including accessing all the services offered by the gateway switch A) as if the subscriber was using a local device connected to the gateway switch. In some embodiments, through the gateway switch, a subscriber can make voice calls via a mobile handset over Internet or WiFi mesh network using VOIP.

In an embodiment of the present invention, an adapter comprises a communications interface, a data interface to connect to a computer (e.g., USB connection, parallel port connection, PCI-express, or other connection), and an embedded controller (e.g., a FPGA, SLIC, etc.).

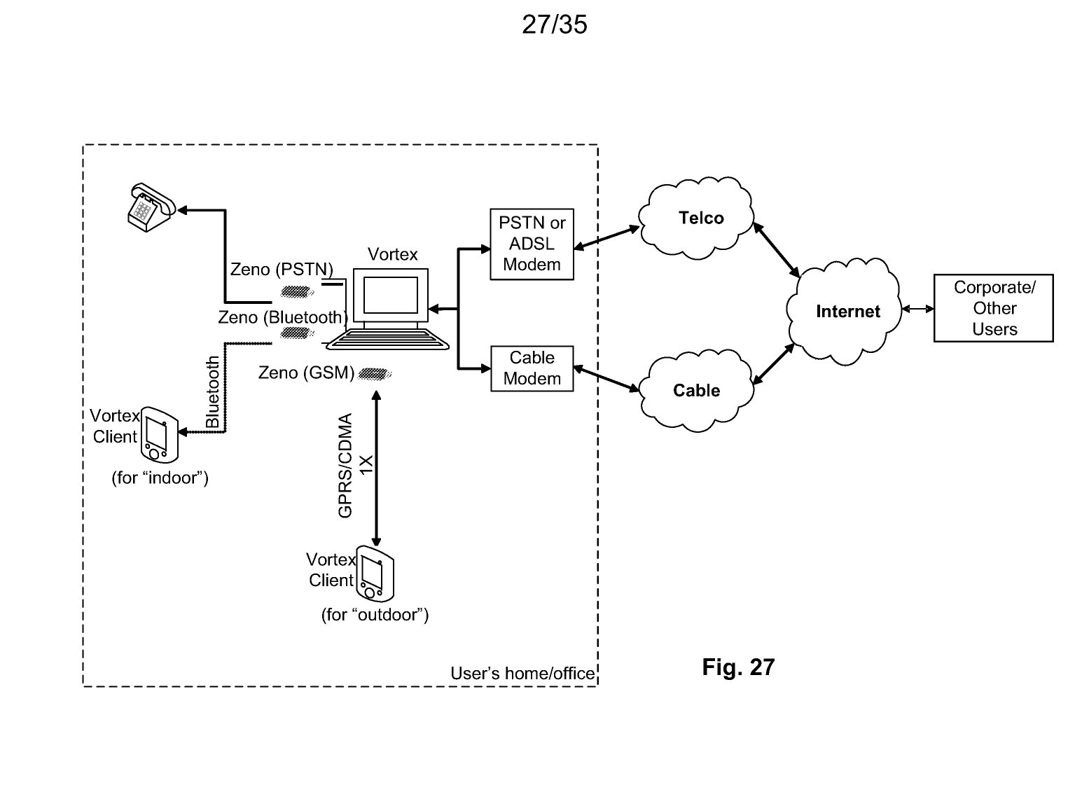

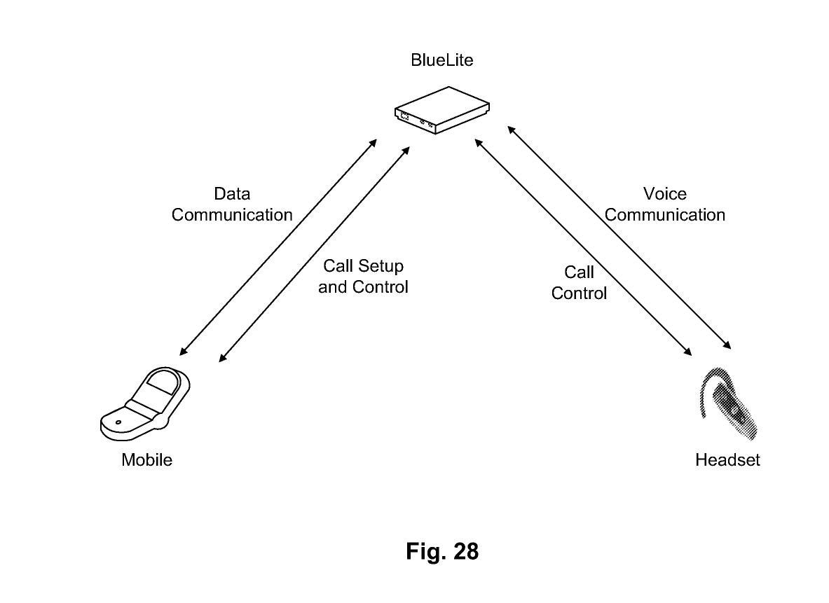

FIG. 27 illustrates various adapters that are connected to a computer and that are running software programs to behave as a RizoNode. An adapter is used to connect a computer to a communications interface (e.g., GSM, BT, PSTN, or other interface). The combination of the adapter, the computer, and software running on the adapter and computer (e.g., Vortex, R-manager, or other software) can be functionally equivalent to a RizoNode, or at the very least provide some of the functionality of a RizoNode. Additionally, multiple adapters supporting various communications interfaces can be connected to a single computer to provide access to multiple networks via the communications interfaces.

In an embodiment of the present invention, an adapter comprises a communications interface, a data interface for connecting with a computer, and a small controller embedded in the adapter. In a sense, an adapter is one interface module of a RizoNode.

In another embodiment of the present invention, an adapter can be designed to support BlueTooth (“BT”) devices, herein referred to as a BlueLite (“BL”) adapter. A BL adapter can comprise one or more BT modules for connecting to one or more BT devices, a WiFi module, a LAN module, a switching control module, a voice processing module, and software to support symmetric switching. The BL adapter can enable voice communications and data communications via a BT device.

A BL adapter can be a BT access point because BT devices (e.g., cellular phones, PDA's, and other BT devices) can connect to a network (e.g., the Internet) via the BL adapter. Generally speaking, the BT standard has two stages, a basic profile and a special profile. The basic profile is widely used by cellular phones, but lacks the capability to connect to a network via a BT access point. Therefore, in order to connect a BT device to a BL adapter, the BL adapter can mimic the special profile using the basic profile. Thus, a cellular device that only supports a basic profile can access a network via a BL adapter. The BL adapter can also support a special profile for connecting a BT device to a network.

FIG. 28 illustrates a diagram of a BL adapter connected to a mobile device and a headset. A cellular phone with BT capability can initiate a call to a destination by signaling a BL adapter to place the call via a network connected to the BL adapter. The BL adapter can then attempt to connect the destination with the cellular phone via the network. The BL adapter can also receive incoming calls via the network and allow the cellular phone to access data via the network.

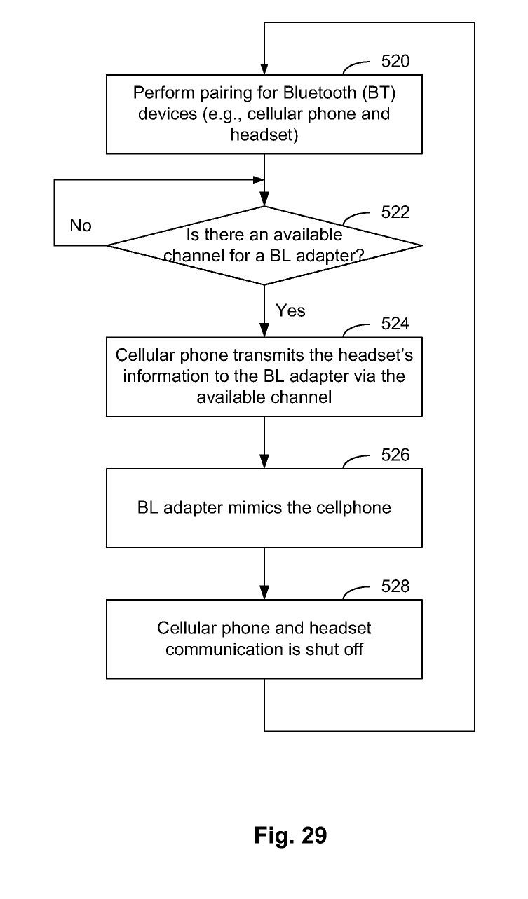

FIG. 29 illustrates a flow chart for setting up a connection between a cellular phone with BT capability, a headset with BT capability, and a BL adapter. A cellular phone and a headset undergo a process referred to as pairing 520, in which one device detects and authenticates the other device and information is exchanged. The cellular phone sends a channel check command to the BL adapter to determine whether the BL adapter has a channel available 522. If not, then the cellular phone can wait until a channel is available. If a channel is available, the cellular phone transmits the headset's BT address and headset's personal identification number (“PIN”) 524. Since the cellular phone and headset have undergone peering and have a connection setup, the cellular phone stores the device name for the headset, device address for the headset, list of services, and other information about the headset.

The BL adapter can then mimic the cellular phone's connection with the headset by sending the headset's BT address and PIN (for security purposes) to the headset 526. The BL adapter can assume the BT address of the cellular phone to spoof itself as the cellular phone to the headset. Software installed on the cellular phone to support the connection with the BL adapter will shut down the connection between the cellular phone and the headset. Thus, the cellular phone can communicate with the headset via the BL adapter 528.

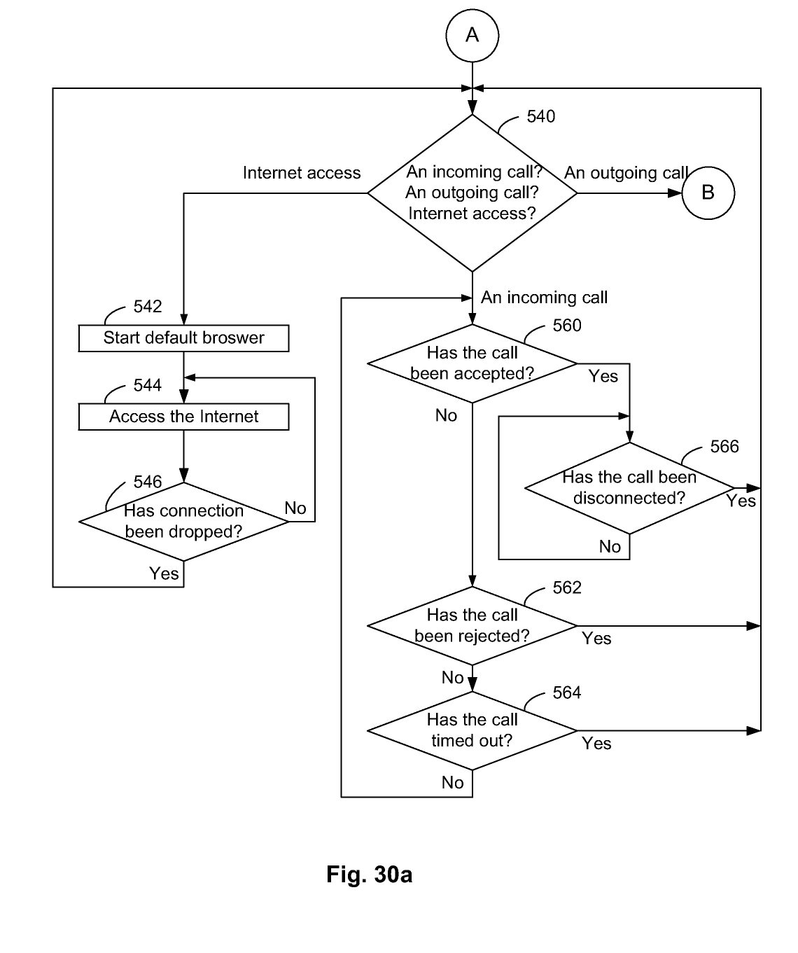

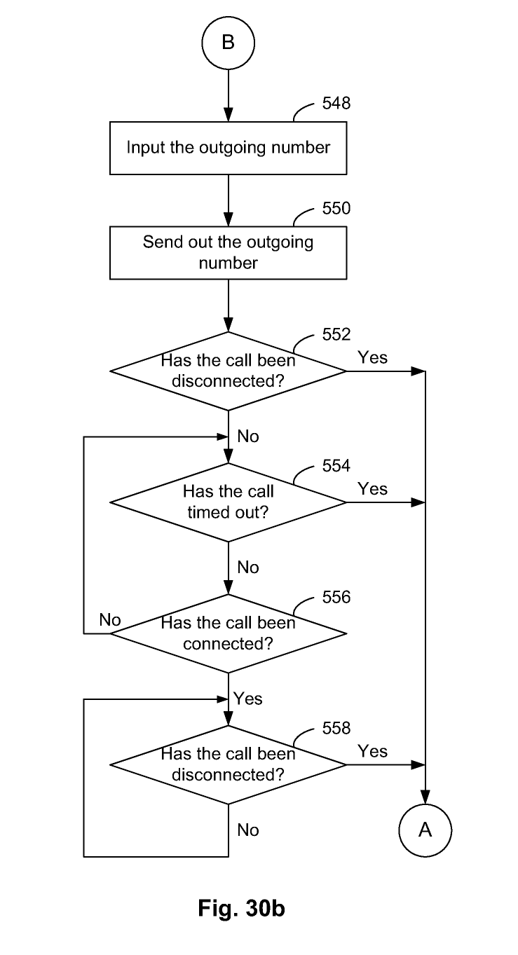

FIGS. 30a and 30b illustrate a process flow for accessing data and voice communications over the network using a cellular phone connected to a BL adapter. First, a selection is made as to whether to access the Internet, place an outgoing call, or accept an incoming call 540. If a user of the cellular phone selects to access the Internet, the user can start a default browser on the cellular phone 542. The browser can be part of the software loaded on to the cellular phone to work with the BL adapter. From the browser, the user can access the Internet. If the connection is dropped due to the user manually ending the session or due to a connection failure 546, then the user can make another selection 540. Otherwise, the user can continue accessing the Internet 544.

If the user places an outgoing call, the user inputs a destination number to be sent to the BL adapter 548. The BL adapter connects to the destination number via a network (e.g., the Internet) 550. The BL adapter can establish this connection in the manner discussed above for RizoNodes using a VoIP/SIP to deliver voice communications over an IP network.

If the caller or the receiver disconnects from the connection 552, then the process loops back to selecting a data and voice communications option 540. If not, the connection is checked to see if it has timed out 554. If the session has timed out, then the process once again loops back to determining the type of data and voice communications to undertake 540.

If the session has not timed out, it is determined whether a connection has been established with the destination number 556. If the connection is successful, the connection is maintained until the connection is broken (e.g., the caller or the receiver hangs up) 558. If the connection is unsuccessful, an option to undertake is determined 540.

If an incoming call is routed via the BL adapter to the cellular phone, it is determined whether the user of the cellular phone accepts the incoming call 560. If the user does not, then the process loops back to determine an action to take 540. If the user accepts the call, then it is determined if the caller or the user hangs up 566. If not, then session continues. If not, the process loops back to determine an action to take 540.

The various sections of the process flow for data and voice communications can be performed one at a time or concurrently. For instance, a user of the cellular phone can access the Internet, and after the user has completed accessing the Internet, the user can place an outgoing call. Additionally, the user can concurrently access the Internet, place a call, and/or accept a call. For instance, the user can make an outgoing call at the same time that the user is accessing the Internet. Furthermore, the caller can be notified of incoming calls even when the caller is currently on an outgoing call.

The following provides an illustrative, but not limiting, exemplary procedure for making voice calls by a subscriber using a gateway switch RizoNode. As illustrated in FIG. 26, when a subscriber A uses a mobile phone to make a voice call, he/she dials a destination phone number (which can be user B's mobile handset number or landline phone number) through the mobile A handset. The user A's handset is programmed in such a way that it first connects to its associated gateway switch A by establishing a connection to the mobile module on the gateway switch A over the mobile network, or by establishing a connection to the PSTN module on the gateway switch A over the PSTN, or by establishing a connection to the LAN/Internet module on the gateway switch A over the Internet.

When the gateway switch A receives the call request with the destination number B, it makes a VOIP call to user B on behalf of user A.

When the call to user B is successful, the gateway switch A makes a call back to user A via a cellular call, a PSTN call, or a VOIP call over Internet. The selection of which method and order of method to make the call can be dependent on a user-specific rule, a service-specific rule, or other considerations.

The gateway switch A makes a conference call between the two established calls, the call to user A and the call to user B, to establish an end-to-end call between the two users. Note that the call can be considered an incoming call for both user A and user B since the gateway switch A calls both user A and user B. Additionally, the mobile handset can also be directly routed to the user B without having the gateway switch setup a conference call.

Note that, in particular, this mechanism enables a VOIP mobile service for mobile users without requiring the users to be present in the proximity of a WiFi/Internet access point (or known as “hot spot”), which is the necessary requirement and fundamental limit for some existing dual-mode phone services (cellular and WiFi) that try to take advantage of VOIP over Internet.

In addition, the subscriber A can also use a landline or a computer phone to make a voice call. When the subscriber A dials a destination phone number (user B's number, either mobile handset or landline phone) through the landline phone or a computer phone which are directly connected to the gateway switch A. The gateway switch A then makes a VOIP call to user B on behalf of user A over Internet or a multi-hop WiFi/WiMax mesh network. When the VOIP call to user B is successful, the gateway switch A then connects the VOIP call with the landline phone or computer phone A via the switching module to establish the end-to-end call from the landline phone or computer phone A to user B.

Furthermore, the gateway switch A can also interconnect other gateway switch via WiFi/WiMax or Internet connections (e.g., IP tunnels) for other network services, such as peer-to-peer IP services for data and/or video content distribution, location-based services (e.g., commerce, advertising, education, etc.), network utility services (e.g., grid supercomputing for commercial or scientific applications), and home-networking services (e.g., household consumer electronic device control, management, security surveillance, etc.).

### Virtual Aggregate Link (“VAL”)

When a RizoNode in a RizoCell requires a large bandwidth to connect to an existing network (e.g., the Internet) to download a large video file, play an interactive video game, or for other purposes, a SN in the RizoCell can create and manage a virtual aggregate link for the RizoNode by combining the available (e.g., unused) bandwidth of other RizoNodes in the RizoCell. Note that each RizoNode may be connected to multiple existing networks by itself and to any or all other RizoNodes via single-hop or multiple-hop wireless links in the RizoCell.

Now, when the RizoNode downloads a file, the segments of the file can be sent to the RizoNode from the existing networks and other neighboring RizoNodes via different wired and wireless connections, and then reassembled locally to the original file at the RizoNode. A special link aggregation software program can operate at the SN and all the RizoNodes in the RizoCell to enable this bandwidth aggregation function. As a result, each RizoNode is enhanced with a much larger total bandwidth connecting to the existing networks (e.g., the Internet) depending on how much available bandwidth can be utilized from the neighboring RizoNodes in the RizoCell. Note that the content of the download file must be pre-segmented by a special database server, e.g., a network management system server of the RizoNet, to coordinate such a download service for content segment assignment and management (e.g., content segment detection and retransmission). The following paragraph describes an embodiment in more specific details.

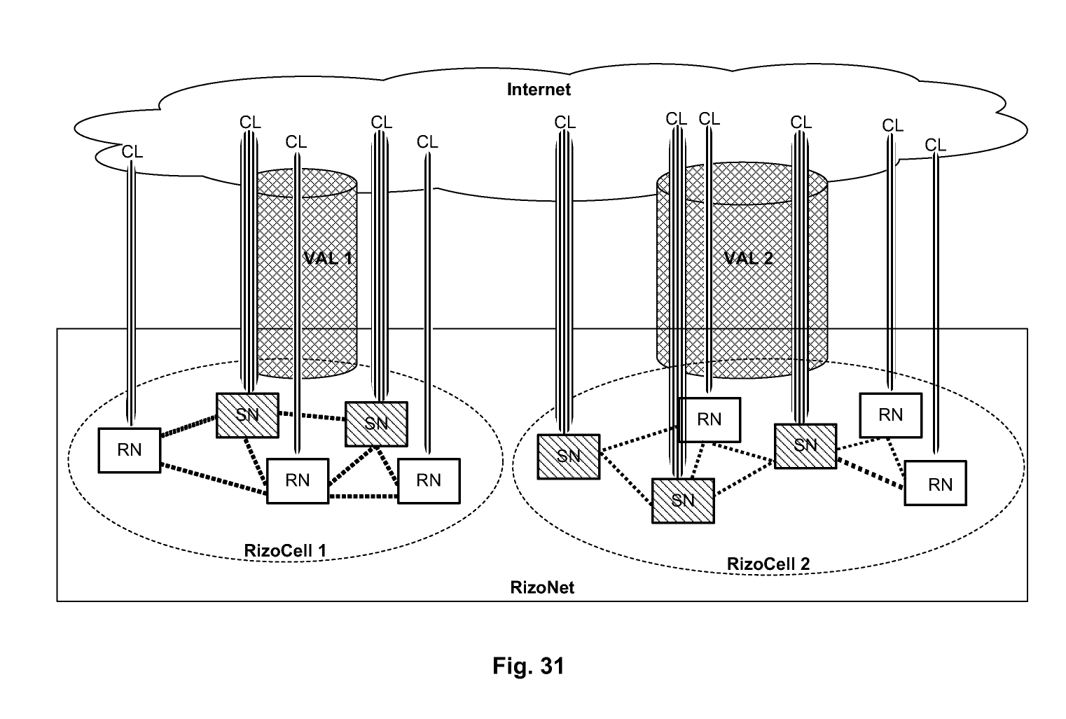

FIG. 31 illustrate a network view of an embodiment of the present invention for a virtual aggregate link. Here, some or all of the RizoNodes in a network cluster are connected to a backbone network (e.g., the Internet). A network cluster can be a RizoCell or a subset of a RizoCell, where there is at least one SN in the network cluster. A virtual aggregate link (“VAL”) to a backbone network (e.g., the Internet) for a network cluster can be defined as a virtual link with aggregate bandwidth connecting to the backbone network from all the RizoNodes within the network cluster. In the context of VAL, each connection to the backbone network can be called a component link (“CL”). The VAL for a network cluster can be formed by a set of CL's in a network cluster, and can be used by the users in the network cluster in a shared fashion.

To access to the backbone network without the mechanism of the VAL, a RizoNode can only use the bandwidth up to its CL bandwidth. With the mechanism of the VAL, a RizoNode can use its CL bandwidth, which directly connects to the RizoNode from the backbone network, plus all the unused bandwidth of the CLs from other RizoNodes. The SN in the network cluster manages the VAL bandwidth-sharing mechanism (e.g., a protocol) with a bandwidth-sharing algorithm for the RizoNodes in the network cluster. Additionally, the VAL can be available to RizoNodes on demand.

### Content Distribution Network (“CDN”)

In some embodiments, the present invention provides a method of content distribution using the RizoNet described herein. The method can include the steps of: (a) authenticating and establishing peer-to-peer connections between two users or among a group of users; (b) delivering content (such as text, music, video, and other data) to a user or a group of users; and (c) managing the content distribution transaction for resource allocation and sharing, virtual aggregate link creation and management for a RizoNode, content segmentation and reassembly, content caching, content directory management, book-keeping, and billing.

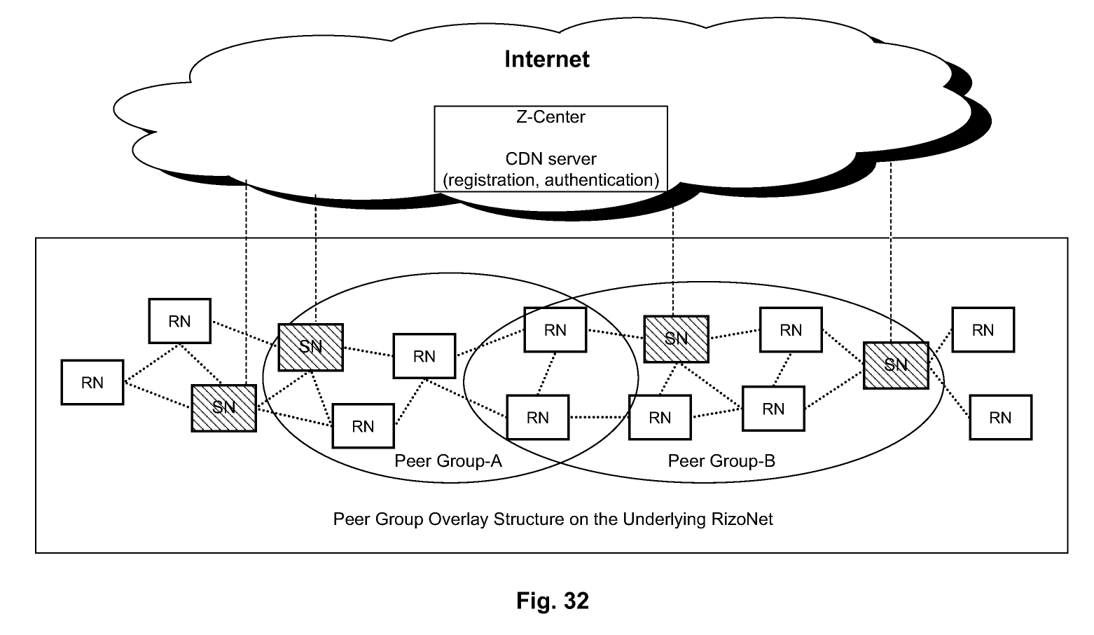

FIG. 32 illustrates an embodiment of the content distribution network (“CDN”) of a RizoNet of the present invention. The RizoNet can support a variety of applications including file sharing, large-scale storage systems (built on top of basic location and routing systems), and media streaming and content distribution.

In some embodiments, the CDN of the RizoNet maintains a peer-to-peer architecture in which some RizoNodes are peers with each other. Resource sharing occurs directly between peers, and peers can join or leave the CDN at any time. The P2P CDN of the RizoNet can be: (1) a fully decentralized system, where all peers are equivalent; (2) a P2P system with centralized directory in which peer nodes interact directly with each other while a central server (e.g., the Z-Center) provides directory service; and (3) a hybrid P2P system, where SNs offer special services, such as location and routing information to peers based on RNs of the RizoNet.

In some embodiments, the P2P CDN of the RizoNet provides classification of peers and peer groups with an overlay structure of peers in terms of locations. The peers are organized into a hash table or tree (e.g., a distributed hash table) so that the location of files or other objects based on the structure can be located. The routing of files for the content distribution network is performed based on the structure and utilizes the previously mentioned underlying routing protocol for communications of the RizoNet.

When a group of RizoNodes joins the CDN of the RizoNet, the topology of the CDN needs to be determined. Criteria (e.g., based on proximity, latency for communications, etc.) are set to determine the neighbors of the nodes in the CDN. A routing algorithm is designed to determine how to choose a neighbor and the next hops for a request. The routing algorithm can consider the geometric aspect of the choice of the neighbors and the next hops.

When a querying peer wants to search for a particular file (e.g., music, video), it sends a request to a SN peer asking for the file. If the SN peer has knowledge of which peers have the file, it responds to the querying peer with a list of potential peers that hold the file. The querying peer then pings other peers on the list of potential peers, and selects the most optimal peer (e.g., based on the shortest path, transfer rate, etc.) to set a direct connection with for downloading the file.

The SN in the RizoCell in which the querying peer resides will set up a virtual aggregate link for the querying peer by combining the available (unused) bandwidth from the group of other RizoNodes in the RizoCell. The selected peer that holds the file can send the segments of the file to the querying peer and also utilize the group of other RizoNodes to relay the various segments of the requested file to the querying peer. Upon arriving at the querying peer, the segments of the file will be reassembled back to the original file.

If the SN peer does not have knowledge of which peers have the requested file, it will ask all the peers in the RizoCell for a response. If no response is received, the SN will pass the request to other SNs in other RizoCells, and so on so forth. A search algorithm based on the above principle can be designed for the CDN based on the RizoNet.

The CDN of the RizoNet provides a wide range of applications. It allows groups that have different communication needs and other potentially different needs for interaction. These needs can be difficult to support cost effectively and efficiently with traditional communication systems.

For example, teenagers can belong to several kinds of these different groups, which require different services and different requirements for each group. These various groups can include classroom groups, groups of friends, hobby groups, neighborhood groups, gaming groups, and the like. The communication of these groups can comprise of one or more of the following: 1) gaming: establishment of a network gaming groups; 2) chatting: multiple groups, everybody can set up a group; 3) content/file transfer (music features, etc.); 4) multimedia messaging including texts, drawings, pictures, sound clips, video clips, files, and other data; 5) connection to Internet via gateways and support for local servers; 6) short range voice and video calls; 7) enabling multicast of high level voice stream; and 8) push services and location-based services. Each individual group may not need all these services, therefore each service can be provided to a group as necessary to conserve resources.

In particular, a push service is defined as a service initiated by an application server toward a mobile or host device. Examples of push services include sending advertisement, news, instant messaging, multimedia messaging, terminating VoIP call, etc. A push service can be combined with location-based services, creating additional value for the originated service. The users of the network may consist of different groups and clubs, which forms closed structures in the service level (password protection/encryption) over the openly shared underlying network.

### Grid Computing

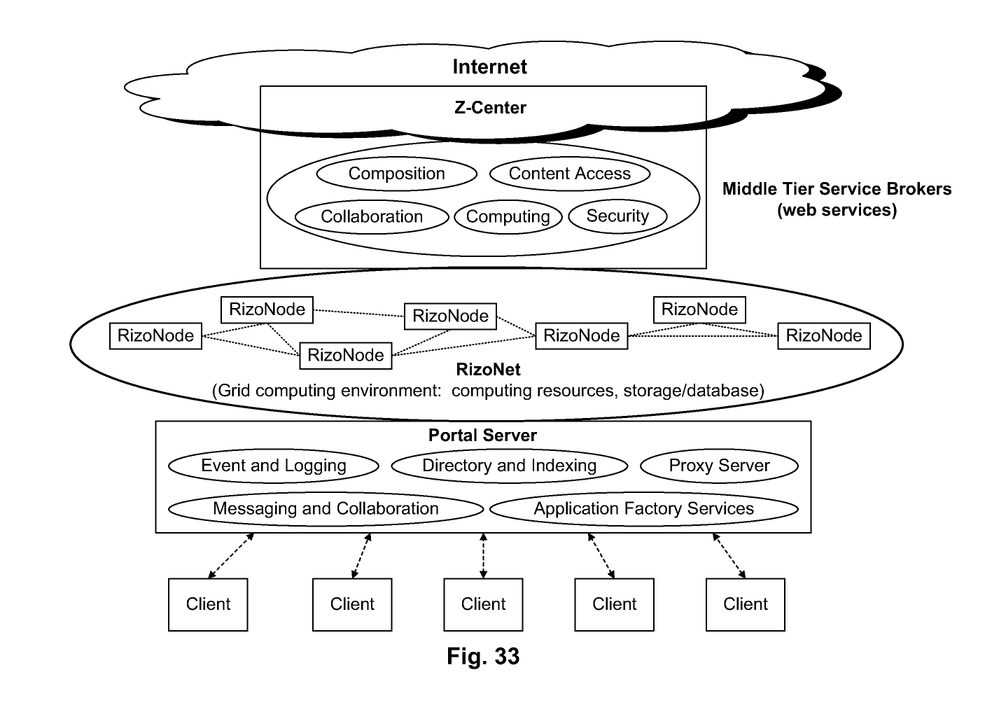

FIG. 33 illustrates an embodiment of a grid computing network (herein may referred to as a “GCN”) of the RizoNet of the present invention. In some embodiments, the present invention provides a method of distributed computation for a project using the systems described herein. The method includes the acts of (a) identifying the RizoNodes to participate in the distributed grid computing according to one or more criteria, (b) dividing the computation project into two or more computational segments, (c) distributing the two or more computational segments to the RizoNodes selected for the computation project, (d) launching the grid computing over the participating RizoNodes, (e) receiving the computational results from the participating RizoNodes, and (f) synthesizing the computational results and reporting the final result of the computation project.

In principle, performing a grid computing for a project involves the following key elements: application, planning, security and policy, computing resource, and storage resource.

The application element can be related to the project to be computed.

The planning element can be related to data location, replica selection, selection of computing, and storage nodes. The planning element can be further broken down into the following: metadata service: location based on data attributes; replica location service: location of one or more physical replicas; replica location service: location of one or more physical replicas; and information services: state of grid resources, performance measurements and predictions.

The security and policy element can involve executing, more specifically, initiating data transfers and computations.

The computing resource element can be for computing the project or components of the project.

The storage resources element can be for data movement and data access.

In some embodiments, the GCN of the RizoNet serves an infrastructure that provides the ability to dynamically link together resources of the RizoNodes and other servers/database in the Z-Center as an ensemble to support the execution of large-scale, resource-intensive, and distributed applications.

In some embodiments, the GCN of the RizoNet can be a distributed computing or distributed system that manages and shares asynchronous resources, and provides a collaborative environment in combining powerful resources, federated computing, and a security structure. It coordinates resource sharing and problem solving in dynamic multi-institutional virtual organizations, as they can access the GCN ubiquitously. Users are presented the illusion of a single, very powerful computer, rather than a collection of disparate machines. Boundaries between RizoNodes as computers become invisible. The GCN schedules application components on participating RizoNodes for computing, manages data transfer, and provides communication and synchronization.

In some embodiments, the GCN of the RizoNet provides the functions and services in the following 4 layers: fabric layer, connectivity layer, resource sharing layer, and collective layer.

With respect to the fabric layer, this layer provides storage systems, computing system, and network. These can be provided by the RizoNodes of the RizoNet.

With respect to the connectivity layer, this layer provides communication protocols (e.g., TCP/IP protocol stack) and security, authentication, and authorization protocols. These protocols are operated by the RizoNodes and some GCN security server in the Z-Center.

With respect to the resource sharing layer, this layer provides resource sharing capabilities. It includes a data access protocol, storage resource management, data filtering or transformation services, database management services, computation resource management services (e.g., local supercomputer scheduler), resource monitoring, and auditing services. These services and functions can be provided by a GCN resource-sharing server in the Z-Center.

With respect to the collective layer, this layer provides general services for coordinating multiple resources. It includes data transport services, data federation services, data filtering or transformation services, general data discovery services, storage management/brokering, computation management/brokering, monitoring/auditing services, request interpretation and planning services, workflow management services, application-specific data discovery services, community authorization services, consistency services with varying levels of consistency, including data versioning, subscription, distributed file systems or distributed databases. These services and functions are provided by some GCN resource coordinating server in the Z-Center.

In some embodiments, the GCN of the RizoNet provides a middleware tier of service brokers to render the services needed to support a common set of applications in a distributed network environment. The services include content access, composition, collaboration, computing, and security. The middleware tier resides in a GCN server of the Z-Center with clients in the RizoNodes.

In some embodiments, a service portal is provided for users to access the services of the GCN of the RizoNet. The main functions of the service portal include: event and logging, directory and indexing, proxy server, messaging and collaboration, and application factory services.

In some embodiments, the GCN of the RizoNet employs P2P technologies (developed for the content distribution network of the RizoNet) for service registration, and P2P caching technologies for data storage to reduce access latency for grid computing.

### Home Network Applications

In some embodiments, the present invention provides a method of control and management for home networking. The method can include the steps of: (a) communicating to household electronics devices (e.g., TV, refrigerator, stereo, air-conditioner, cooking equipment, security system, water usage monitoring, electricity usage monitoring, and other home devices, etc.) according to a protocol from a RizoNode, which serves as the control and management center for a household; (b) configuring the household electronics devices remotely by the RizoNode over the RizoNet; and (c) receiving and monitoring the status of electronics devices remotely through the RizoNode over the RizoNet.

The household's electronic devices can also be special sensors for monitoring health vital-sign conditions (e.g., heart rates, blood pressure, glucose, etc.) and home environmental conditions (e.g., motion, bed pressure, room temperature, fire, smoke, gas leaking, etc.) to provide telehealth and telecare services for people at home, especially for vulnerable people (e.g., elderly, chronic disease patients, pregnant women, children, etc.).

The RizoNet can be ideal for neighborhood and community networking. In a neighborhood network, RizoNodes can be installed at households to enable connections between houses. This network can be utilized for communication between neighbors and can access networks via Internet service providers (“ISPs”). Furthermore, computers, PDAs, and other devices can utilize the RizoNodes as access points to other networks. In areas where wireless coverage is not available, the RizoNet dynamically extends the wireless coverage.

An ISP can build one or more network POPs (“Point-of-Presences”) to connect to one or more RizoNodes in the RizoNet to allow users in each household to connect to the Internet (or other networks). In addition, other service providers or business entities can utilize the RizoNet to provide value-added services, such as real estate management and neighborhood security services (e.g. surveillance cameras).

Home-networking can refer to local area networking in a home environment. Currently, home-networking is taking its first steps. Wired networking has the problem of cabling that requires specific skills and construction work. Wireless self-configuring networks are ideal to solve challenges in this application area. First, the need for home-networking emerges when a household has several computers and or other devices. Also entertainment electronics (e.g., TVs, set top boxes, DVD players, stereos, game consoles, etc.) need home-networking, where ad-hoc networks may be used for transferring contents and control information. Electricity meters, gas meters, water meters, refrigerator, cooking equipment, heating and air conditioning systems, security system, smart home appliances, and other household devices require control and remote access. In addition, these devices may also be networked.

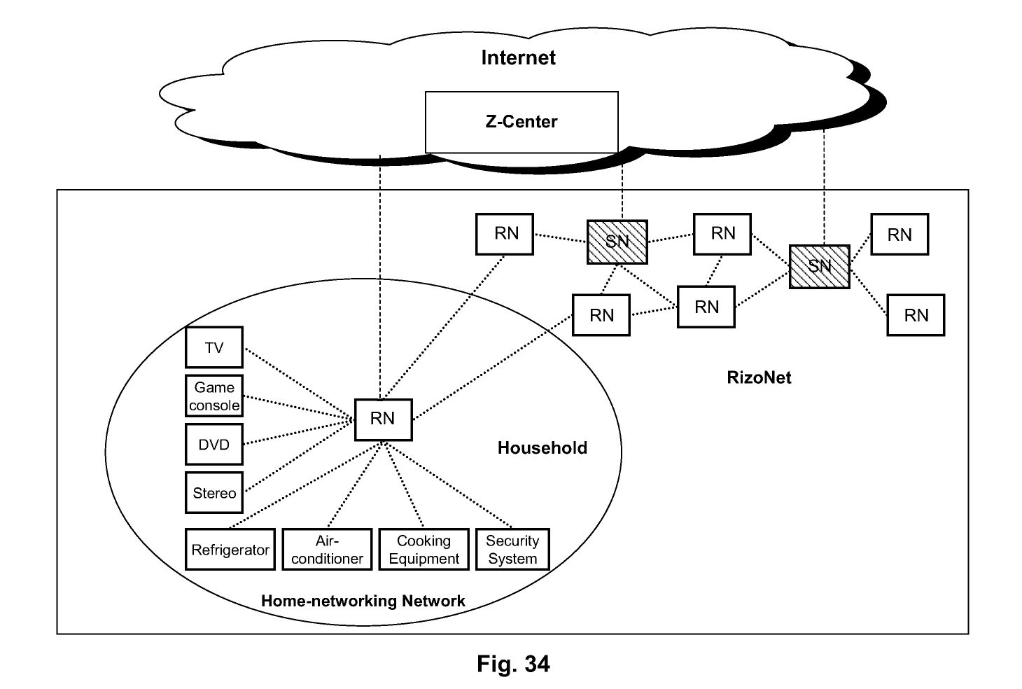

FIG. 34 illustrates an embodiment of the Home-Networking Network (HNN) of the RizoNet of the present invention. A RizoNode is installed in a household as a node of the RizoNet, and also serves as the control and management center for the FINN of the household. The RN connects to the household consumer electronics devices, such as TVs, set top boxes, DVD players, stereos, games consoles, electricity meters, gas meters, water meters, a refrigerator, cooking equipment, heating and air conditioning systems, and a security system through wireless links (assuming the consumer electronics devices have a wireless module built in).

In some embodiments, the wireless links may include WiFi, Bluetooth, Zigbee, and other short-range radio technologies. In some embodiments, the present invention provides a method to control and manage the FINN for home networking. The method includes the steps of (a) communicating to household electronics devices according to a communications protocol operated by the RizoNode in the household, (b) configuring the household electronics devices remotely through the RizoNode over the RizoNet and Internet, and (c) receiving and monitoring the status of electronics devices remotely through the RizoNode over the RizoNet.

In some embodiments, a RizoNode can aggregate data received by one communications interface or by a set of communications interfaces. The RizoNode can transmit the aggregated data to a specified device or a specified destination based on a schedule or a triggering event.

For instance, a RizoNode can be used for energy management of consumer electronics devices (“CEDs”) in a home. The CEDs can communicate with the RizoNode via a HNN by sending real-time energy usage information to the RizoNode. The CEDs can send this information using WiFi, Bluetooth, Zigbee, other short-range radio technologies, or combinations thereof. The sent data can be stored and aggregated by the RizoNode to keep track of the energy usage of the home.

The RizoNode can then periodically transmit the total amount of energy used to an energy monitoring server via the Internet (or other networks). If the energy monitoring server chooses to reduce the amount of energy used by that home, the energy monitoring server can transmit a request to the RizoNode to turn off one or more of the CEDs. The RizoNode can also transmit the energy usage information to a user of the RizoNode for real-time viewing of the energy consumption of the home.

As exemplified above, there are many different applications which can benefit from the RizoNet. A key advantage provided is that the benefits of the RizoNet are established by leveraging the current network infrastructure, yet keeping it self-contained and locally independent.

While the present invention has been described with reference to certain preferred embodiments or methods, it is to be understood that the present invention is not limited to such specific embodiments or methods. Rather, it is the inventor's contention that the invention be understood and construed in its broadest meaning as reflected by the following claims. Thus, these claims are to be understood as incorporating not only the preferred methods described herein but all those other and further alterations and modifications as would be apparent to those of ordinary skilled in the art.

We claim:

1. A method for operating a network having one or more nodes wherein each of the nodes having one or more resources, comprising the steps of:
forming the network using one or more nodes, wherein certain one or more of the nodes is a gateway connecting to two or more different network connection types; and
managing the one or more nodes of the network;
wherein the nodes are segregated into one or more cells each having one or more of the nodes and one or more supernodes; wherein the nodes within the same cell are interconnected; and wherein the supernodes are interconnected.

2. The method of claim 1 further comprising the steps of:
aggregating the resources of the nodes; and
utilizing the aggregated resources in processing data in the network.

3. The method of claim 1 wherein the nodes and the supernodes of the same cell are interconnected in a mesh topology.

4. The method of claim 1 wherein the supernodes are interconnected by network tunnels.

5. The method of claim 1 wherein to transfer data from a first node of a first cell to a second node of a second cell, where the first cell and the second cell are different cells, the data is transferred through a supernode of the first cell and a supernode of the second cell.

6. The method of claim 1 wherein the forming step further comprises the substeps of:
receiving a request from a requesting node for joining the network;
detecting one or more neighboring nodes of the requesting node;
connecting the neighboring nodes and the requesting node;
updating information regarding the connected neighboring nodes and the requesting node;
segregating the connected neighboring nodes and the requesting node into one or more cells in accordance with one or more partitioning criteria; and
delegating one or more nodes of each of the cells as a supernode.

7. The method of claim 6 wherein the segregating step further comprises at least one of the substeps of:
if a maximum number of nodes has been reached for the network, partitioning a selected group of nodes of the network into one or more cells;
if a maximum number of nodes has been reached for a selected one of the cells, partitioning a selected group of nodes of the selected one of the cells into one or more cells;
if a maximum number of links for a group of nodes has been reached, partitioning the group of nodes into one or more cells;
if a maximum length of a predefined longest path has been reached for a group of nodes, partitioning the group of nodes into one or more cells;
if a maximum packet throughput time for a group of nodes has been reached, partitioning the group of nodes into one or more cells; and
if one or more predefined administrative criteria for a group of nodes have been reached, partitioning the group of nodes into one or more cells.

8. The method of claim 1 wherein each cell may have a sub-cell and the sub-cell may have one or more nodes and one or more supernodes.

9. The method of claim 6 wherein the delegating step further comprises the substeps of:
evaluating each node of the cell in relation to other nodes in the cell in accordance with one or more supernode selection criteria; and
determining one or more of the evaluated nodes as a supernode in accordance with the supernode selection criteria.

10. The method of claim 9 wherein the supernode selection criteria include one or more of the distance relationship between the evaluated node and other nodes, the speed relationship between the evaluated node and other nodes, the bandwidth availability for the nodes, and one or more predefined administrative criteria.

11. The method of claim 1 wherein, in routing data from a source node to a destination node, the method further comprises the steps of:
if the source node and the destination node are not in the same cell,
finding a source supernode of the cell of the source node and a destination supernode of the cell of the destination node;
determining a first routing path between the source node and the source supernode according to a first routing algorithm;
determining a second routing path between the destination node and the destination supernode according to a second routing algorithm;
determining a third routing path between the source supernode and the destination supernode according to a third routing algorithm; and
aggregating the first routing path, the second routing path, and the third routing path to generate a primary path from the source node to the destination node.

12. The method of claim 1 wherein, in routing data from a source node to a destination node, the method further comprises the step of:
if the source node and the destination node are in the same cell, determining a first routing path between the source node and the destination node according to a first routing algorithm.

13. The method of claim 1 wherein a cell having one or more storing nodes for storing data and each of the storing nodes having a certain amount of available storage, wherein the cell having a supernode, the method further comprises the steps of:
determining the size of the data to be stored;
determining the available storage of a selected storing node; and
if the available storage of the selected storing node is less than the size of the data,
determining by the supernode the availability of storage of the cell;
directing by the supernode to the storing node for the storing node to partition the data into two or more segments; and
transmitting the segments to the other storing nodes in the cell for storage.

14. The method of claim 1 wherein each of the nodes in the one or more cells has a certain amount of available bandwidth and the available bandwidth is aggregated into a single link for transmitting or receiving data.

15. The method of claim 2 wherein, in transceiving data from a node of a cell that is one of the cells, wherein the cell has a supernode, the utilizing step further comprises the substeps of:
determining the size of the data to be transceived;
calculating by the supernode available bandwidth of the one or more cells;
directing by the supernode to the node for the node to partition the data into two or more segments; and
transceiving the segments by the node and the other nodes.

16. The method of claim 15 wherein the other nodes are within the same cell or in different cells.

17. The method of claim 2 wherein, in performing a computational project, the utilizing step further comprises the substeps of:
dividing the computational project into two or more computational segments;
selecting a plurality of the nodes for processing the computational segments;
distributing the computational segments to the selected nodes;
processing the computational segments by the selected nodes; and
aggregating the processed computational segments.

18. The method of claim 17 wherein the selected nodes are within the same cell or in different cells.

19. The method of claim 4 wherein upon a supernode of the cells failing to respond, the network tunnels between supernodes are reconfigured.

20. The method of claim 1 wherein upon any one of the nodes of the cells failing to respond, the links between the non-responding node and other nodes of the cell are reconfigured.

21. The method of claim 1 wherein the managing step including managing the nodes and the cells for one or more of fault tolerance, configuration, accounting, provisioning, and security.

22. The method of claim 1 wherein the network connection types include one or more of a dial-up connection type, a direct link type, a wireless connection type, a virtual private network type, a TCP/IP connection type, a cellular connection type, and a satellite connection type.

23. A method for operating a network having one or more nodes wherein each of the nodes having one or more resources, comprising the steps of:
forming the network using one or more nodes, wherein certain one or more of the nodes is a gateway connecting to two or more different network connection types; and
managing the one or more nodes of the network;
wherein the nodes are segregated into one or more cells each having one or more of the nodes and one or more supernodes interconnected in a mesh topology; wherein the nodes within the same cell are interconnected; and wherein the supernodes are interconnected by network tunnels; and
wherein to transfer data from a first node of a first cell to a second node of a second cell, where the first cell and the second cell are different cells, the data is transferred through a supernode of the first cell and a supernode of the second cell.

24. The method of claim 23 wherein the forming step further comprises the substeps of:
receiving a request from a requesting node for joining the network;
detecting one or more neighboring nodes of the requesting node;
connecting the neighboring nodes and the requesting node;
updating information regarding the connected neighboring nodes and the requesting node;
segregating the connected neighboring nodes and the requesting node into one or more cells in accordance with one or more partitioning criteria; and
delegating one or more nodes of each of the cells as a supernode;
wherein if a maximum number of nodes has been reached for the network, partitioning a selected group of nodes of the network into one or more cells;
wherein if a maximum number of nodes has been reached for a selected one of the cells, partitioning a selected group of nodes of the selected one of the cells into one or more cells;
wherein if a maximum number of links for a group of nodes has been reached, partitioning the group of nodes into one or more cells;
wherein if a maximum length of a predefined longest path has been reached for a group of nodes, partitioning the group of nodes into one or more cells;
wherein if a maximum packet throughput time for a group of nodes has been reached, partitioning the group of nodes into one or more cells; and
wherein if one or more predefined administrative criteria for a group of nodes have been reached, partitioning the group of nodes into one or more cells.

25. The method of claim 24 wherein the delegating step further comprises the substeps of:
evaluating each node of the cell in relation to other nodes in the cell in accordance with one or more supernode selection criteria; and
determining one or more of the evaluated nodes as a supernode in accordance with the supernode selection criteria;
wherein the supernode selection criteria include one or more of the distance relationship between the evaluated node and other nodes, the speed relationship between the evaluated node and other nodes, the bandwidth availability for the nodes, and one or more predefined administrative criteria.

26. A method for operating a network having one or more nodes wherein each of the nodes having one or more resources, comprising the steps of:
forming the network using one or more nodes, wherein certain one or more of the nodes is a gateway connecting to two or more different network connection types;
managing the one or more nodes of the network;
aggregating the resources of the nodes; and
utilizing the aggregated resources in processing data in the network;
wherein the nodes are segregated into one or more cells each having one or more of the nodes and one or more supernodes;
wherein the nodes within the same cell are interconnected; and wherein the supernodes are interconnected;
wherein to transfer data from a first node of a first cell to a second node of a second cell, where the first cell and the second cell are different cells, the data is transferred through a supernode of the first cell and a supernode of the second cell; and
wherein one or more of the nodes are storing nodes for storing data and each of the storing nodes having a certain amount of available storage, the utilizing step further comprises the substeps of:
determining the size of the data to be stored;
determining the available storage of a selected storing node; and
if the available storage of the selected storing node is less than the size of the data,
determining by the supernode of the storing node the availability of storage of the respective cell of the storing node;
directing by the supernode to the storing node for the storing node to partition the data into two or more segments; and
transmitting the segments to the other storing nodes in the cell for storage.

27. A method for operating a network having one or more nodes wherein each of the nodes having one or more resources, comprising the steps of:
forming the network using one or more nodes, wherein certain one or more of the nodes is a gateway connecting to two or more different network connection types;
managing the one or more nodes of the network;
aggregating the resources of the nodes; and
utilizing the aggregated resources in processing data in the network;
wherein the nodes are segregated into one or more cells each having one or more of the nodes and one or more supernodes;
wherein the nodes within the same cell are interconnected; and wherein the supernodes are interconnected;
wherein to transfer data from a first node of a first cell to a second node of a second cell, where the first cell and the second cell are different cells, the data is transferred through a supernode of the first cell and a supernode of the second cell;
wherein each of the nodes in the one or more cells has a certain amount of available bandwidth and the available bandwidth is aggregated in to a single link for transmitting or receiving data; and
wherein, in transceiving data from a node of a cell that is one of the cells, wherein the cell has a supernode, the utilizing step further comprises the substeps of:
determining the size of the data to be transceived;
calculating by the supernode available bandwidth of the one or more cells;
directing by the supernode to the node for the node to partition the data into two or more segments and to transceive the segments by the node and one or more other nodes; and
transceiving the segments by the node and the other nodes.

28. A method for operating a network having one or more nodes wherein each of the nodes having one or more resources, comprising the steps of:
forming the network using one or more nodes, wherein certain one or more of the nodes is a gateway connecting to two or more different network connection types;
managing the one or more nodes of the network;
aggregating the resources of the nodes; and
utilizing the aggregated resources in processing data in the network;
wherein the nodes are segregated into one or more cells each having one or more of the nodes and one or more supernodes;
wherein the nodes within the same cell are interconnected; and wherein the supernodes are interconnected;
wherein to transfer data from a first node of a first cell to a second node of a second cell, where the first cell and the second cell are different cells, the data is transferred through a supernode of the first cell and a supernode of the second cell; and
wherein, in performing a computational project, the utilizing step further comprises the substeps of:
dividing the computational project into two or more computational segments;
selecting a plurality of the nodes for processing the computational segments;
distributing the computational segments to the selected nodes;
processing the computational segments by the selected nodes; and
aggregating the processed computational segments.

29. A method for operating a network having one or more nodes wherein each of the nodes having one or more resources, comprising the steps of:
forming the network using one or more nodes, wherein certain one or more of the nodes is a gateway connecting to two or more different network connection types, comprising the substeps of:
receiving a request from a requesting node for joining the network;
detecting one or more neighboring nodes of the requesting node;
connecting the neighboring nodes and the requesting node;
updating information regarding the connected neighboring nodes and the requesting node;
segregating the connected neighboring nodes and the requesting node into one or more cells in accordance with one or more partitioning criteria; and
delegating one or more nodes of each of the cells as a supernode, comprising the substeps of:
evaluating each node of the cell in relation to other nodes in the cell in accordance with one or more supernode selection criteria; and
determining one or more of the evaluated nodes as a supernode in accordance with the supernode selection criteria;
wherein the supernode selection criteria include one or more of the distance relationship between the evaluated node and other nodes, the speed relationship between the evaluated node and other nodes, the bandwidth availability for the nodes, and one or more predefined administrative criteria;
wherein if a maximum number of nodes has been reached for the network, partitioning a selected group of nodes of the network into one or more cells;
wherein if a maximum number of nodes has been reached for a selected one of the cells, partitioning a selected group of nodes of the selected one of the cells into one or more cells;
wherein if a maximum number of links for a group of nodes has been reached, partitioning the group of nodes into one or more cells;
wherein if a maximum length of a predefined longest path has been reached for a group of nodes, partitioning the group of nodes into one or more cells;
wherein if a maximum packet throughput time for a group of nodes has been reached, partitioning the group of nodes into one or more cells; and
wherein if one or more predefined administrative criteria for a group of nodes have been reached, partitioning the group of nodes into one or more cells; and
managing the one or more nodes of the network;
wherein the nodes are segregated into one or more cells each having one or more of the nodes and one or more supernodes interconnected in a mesh topology; wherein the nodes within the same cell are interconnected; and wherein the supernodes are interconnected by network tunnels.

30. A network, comprising:
one or more nodes, wherein certain one or more of the nodes is a gateway connecting two or more network connection types, and wherein each of the nodes having one or more resources; and
one or more supernodes;
wherein the nodes are segregated into one or more cells each having one or more of the nodes and one or more of the supernodes; and wherein the nodes and the supernodes of the same cell are interconnected and the supernodes of the cells are interconnected.

31. The network of claim 30 wherein the resources of the nodes are aggregated and wherein the aggregated resources are utilized in processing data in the network.

32. The network of claim 31 wherein one of the aggregated resources is data storage.

33. The network of claim 31 wherein one of the aggregated resources is an aggregated computing resource.

34. The network of claim 33 wherein aggregated computing resource is available upon demand.

35. The network of claim 31 wherein one of the aggregated resources is an aggregated bandwidth for transmitting and receiving data.

36. The network of claim 35 wherein the aggregated bandwidth is available upon demand for transmitting and receiving data.

37. The network of claim 35 wherein the aggregated bandwidth is utilized within each of the cells.

38. The network of claim 30 wherein the network connection types include one or more of a dial-up connection type, a direct link type, a wireless connection type, a virtual private network type, a TCP/IP connection type, a cellular connection type, and a satellite connection type.

39. The network of claim 30 wherein the supernodes of the cells are connected by network tunnels.
